(19) United States
(12) Patent Application Publication
(10) Pub. No.: US 2006/0082536 A1
(43) Pub. Date: Apr. 20, 2006

(54) Display device and driving method

(76) Inventors: Jun Koyama, Sagamihara (JP); Shunpei Yamazaki, Tokyo (JP)

Correspondence Address: FISH & RICHARDSON P.C., P.O. BOX 1022, MINNEAPOLIS, MN, 55440-1022, US

(21) Appl. No.: 11/236,804

(22) Filed: Sep. 28, 2005

(30) Foreign Application Priority Data
Oct. 4, 2004 (JP) 2004-292010

(51) Int. Cl. G09G 3/36

(52) U.S. Cl. 345/100

(57) ABSTRACT

A display device capable of switching a screen between a display in the vertical direction and a display in a horizontal direction. The scanning direction of a first gate signal line driver circuit is perpendicular to that of a source signal line driver circuit, and the scanning direction of a second gate signal line driver circuit is perpendicular to that of the first gate signal line driver circuit. In a normal display, the vertical scanning of a screen is performed by the first gate signal line driver circuit. Meanwhile, in the case of switching between the display in the vertical direction and the display in the horizontal direction, the vertical scanning of the screen is performed by the second gate signal line driver circuit. The screen is driven by a field sequential method and a pixel is not divided into RGB; therefore, switching of the display direction can be facilitated.

### BACKGROUND OF THE INVENTION

1. Field of the Invention

The present invention relates to a display device where a pixel portion is formed using a liquid crystal element, and an electronic apparatus using such a display device for a display portion. In particular, the invention relates to a display device adopting a field sequential method, and an electronic apparatus using such a display device for a display portion.

2. Description of the Related Art

In recent years, a display device where a semiconductor thin film is formed over an insulator such as a glass substrate, particularly an electronic circuit using a thin film transistor (hereinafter referred to as a TFT) has been used in various fields. In particular, the TFT is often used for a display device, and an active matrix display device typified by an LCD (Liquid Crystal Display) is widely used for many products. The active matrix display device using TFTs has hundreds of thousands to millions of pixels arranged in matrix, and displays images by controlling charge of each pixel by a TFT disposed in each pixel.

Further recently, technologies related to a polysilicon TFT have been developed to simultaneously form a pixel TFT constituting a pixel and a driver circuit at the periphery of a pixel portion over the same substrate. These technologies have contributed greatly to miniaturization and low power consumption of the device. As a result, the display device has been indispensable for a display portion and the like of a mobile information terminal the application range of which has spread recently.

FIG. 2A shows an example of a common display device. FIG. 2A shows an example of a liquid crystal display device where a pixel portion and a driver circuit are simultaneously formed over an insulator. A pixel portion 201 is formed at the center of a substrate 200, and a source signal line driver circuit 202, gate signal line driver circuits 203 and the like are formed at the periphery of the pixel portion 201. Although the gate signal line driver circuits 203 are symmetrically disposed on the left and right sides of the pixel portion 201 in FIG. 2A, they may be disposed on only one side. However, in view of the reliability, efficiency and the like of the circuit operation, it is preferable that the driver circuits be disposed symmetrically as shown in FIG. 2A.

Signals are externally inputted to the source signal line driver circuit 202 and the gate signal line driver circuits 203 through a flexible printed circuit (FPC) 204.

An opposite substrate 210 is provided with an opposite electrode and the like, and attached to the substrate 200 through a sealing member 205 so as to have some space. Then, a liquid crystal material is injected to the space between the substrate 200 and the opposite substrate 210 from an inlet that has been prepared in advance, and the inlet is sealed with a sealant 206.

The pixel portion 201 has, as shown in FIG. 2B, m source signal lines and n gate signal lines that are perpendicular to each other. A pixel shown in FIG. 2C is formed at an intersection 220 of the source signal line and the gate signal line. The pixel includes a source signal line 221, a gate signal line 222, a pixel TFT 223, a liquid crystal element 224, a storage capacitor 225, and an opposite electrode 226. The pixel portion 201 has m×n pixels herein.

Operation of the display device is briefly described with reference to FIGS. 5A to 5C. In general, writing of screen is performed about 60 times per second in order that flicker of the screen is not recognized by the human eye. A period 501, that is, a period for writing a screen once is called one frame period (FIG. 5A).

During one frame period, the gate signal lines are sequentially selected from the first row. A period 504 for selecting one row is referred to as one horizontal period. A period 502 for completing the selection of the first to the last (n-th) row is referred to as a line scanning period. Then, after a vertical fly-back period 503, the same operation is performed in the next frame period (FIG. 5B).

During one horizontal period, video signals are sequentially written from the source signal line to pixels of a selected row. This period 505 is referred to as a dot sampling period. A period 507 for writing a video signal to one pixel is referred to as one dot sampling period. When writing of video signals to pixels of one row is completed, a horizontal fly-back period 506 appears, and then the same operation is performed in the next horizontal period (FIG. 5C).

Next, operation of the circuit is described specifically. FIG. 6A shows a configuration example of the source signal line driver circuit of the display device, which includes a shift register 602 having a plurality of stages of flip flop circuits (FF) 601, a NAND 603, a buffer 604, and a sampling switch 605.

The operation is described with reference to FIG. 6B. The shift register 602 outputs pulses sequentially from the first stage in accordance with a clock signal (CK), a clock inverted signal (CKb) and a start pulse (SP).

If the pulses outputted from the shift register 602 overlap in adjacent stages, the pulses are inputted to the NAND 603 to be converted into pulses that do not overlap. Subsequently, the output of the NAND 603 is inputted to the buffer 604 and a sampling pulse is obtained.

When the sampling pulse is inputted to the sampling switch 605, the sampling switch 605 is turned on while the potential of a video signal (Video) is charged in the source signal line connected to the sampling switch. At the same time, the video signal is written to a pixel connected to the source signal line of the row connected to the selected gate signal line. In FIG. 6B, a period 610 is one dot sampling period.

A gate signal line driver circuit shown in FIG. 7A is described. Substantially similarly to the source signal line driver circuit, the gate signal line driver circuit includes a shift register 702 having a plurality of stages of flip flops 701, a NAND 703 and a buffer 704.

Operation of the gate signal line driver circuit is described with reference to FIG. 7B. Similarly to the source signal line driver circuit, the shift register 702 outputs pulses sequentially from the first stage in accordance with a clock signal (CK), a clock inverted signal (CKb) and a start pulse (SP).

If the pulses outputted from the shift register 702 overlap in adjacent stages, the pulses are inputted to the NAND 703 to be converted into pulses that do not overlap. Subsequently, the output of the NAND 703 is inputted to the buffer 704 and a gate signal line selection pulse is obtained.

As set forth above, a video signal written to the source signal line is inputted to each pixel of a row to which the gate signal line selection pulse is inputted. In FIG. 7B, a period 710 is one horizontal period and a period 720 is the aforementioned one dot sampling period.

A display device is generally used while being fixed in a predetermined direction. However, in the case of a display device for multifunction applications, such as a personal computer, the display device is required to be used in the horizontal direction or in the vertical direction depending on applications. In such a case, images can be displayed with a housing of the display device rotated by 90° as shown in FIG. 3A.

In that case, the display device is driven at the timing shown in FIGS. 10A to 10C. A period 1001 is referred to as one frame period. During one frame period, gate signal lines are selected sequentially from the first row. A period 1004 for selecting one row is referred to as one horizontal period. A period 1002 for completing the selection of the first to the last (m-th) row is referred to as a line scanning period. Then, after a vertical fly-back period 1003, the same operation is performed in the next frame period. During one horizontal period, video signals are sequentially written from the source signal line to pixels of a selected row. This period 1005 is referred to as a dot sampling period. A period 1007 for writing a video signal to one pixel is referred to as one dot sampling period. When writing of video signals to pixels of one row is completed, a horizontal fly-back period 1006 appears, and then the same operation is performed in the next horizontal period.

Some of the latest mobile phones are provided with a television receiving function. Such mobile phones are desirably used in the horizontal direction when television images are displayed, while used in the vertical direction when text data is displayed.

The pixel portion of the active matrix display device has m×n pixels arranged in matrix as shown in FIG. 2B. Video signals are sequentially written in the order of (1, 1), (1, 2), (1, 3), (1, 4) . . . , and when writing of a video signal to a pixel (1, m) is completed, one horizontal period is completed. This operation is repeated n times, and when writing of a video signal to a pixel (m, n) is completed, writing of one screen is completed.

Description is made with reference to FIG. 3A again. Reference numerals 301 and 302 denote pixels (1, 1) to which a video signal is inputted first in the case of a display in the horizontal direction (left) and a display in the vertical direction (right), respectively. When the same image is displayed on the screen in the vertical direction and the screen in the horizontal direction as shown in FIG. 3A, video signals are inputted in the order of the top left, top right, . . . , and bottom right if the video signals correspond to the display in the horizontal direction. Meanwhile, these video signals are used for the display in the vertical direction, the video signals are inputted in the order of the top right, bottom right, . . . , and bottom left, since the order of writing to the display device itself does not change.

However, it is not effective to change the format of the video signals in each case, since switching of the display device between the display in the vertical direction and the display in the horizontal direction is preferably performed with flexibility. Therefore, images are displayed by temporarily storing video signals in a frame memory and reading the video signals therefrom.

Since the frame memory stores a video signal of each pixel for each memory cell, the video signal can be read from any address independently of the writing order. By changing the order of reading video signals that have been written to the frame memory, the aforementioned switching between the display in the vertical direction and the display in the horizontal direction can be performed.

In the frame memory storing video signals for one frame period, each memory circuit is controlled by an address as shown in FIG. 3B. Accordingly, when video signals are inputted, they are written in the order of (1, 1), (2, 1), . . . , (m, 1), (1, 2), (2, 2), . . . , (m, 2), . . . , (1, n), (2, n), and (m, n). In the case of the display in the horizontal direction, the video signals are read in the same order as the writing order.

On the other hand, in the case of the display in the vertical direction, the video signals are read in the order of (m, 1), (m, 2), . . . , (m, n), (m−1, 1), (m−2, 2), . . . , (m−1, n), . . . , (1, 1), (1, 2), and (1, n), thereby the image shown in FIG. 3A is displayed.

In general, the frame memory is provided for at least two frame periods (first frame memory 402 and a second frame memory 403) as shown in FIG. 4A. While a video signal 401 is written to one of the two frame memories, a video signal is read from the other frame memory and converted in a format converter 404 to display an image.

In this manner, switching of the display direction can be performed while the display device is driven normally. However, the display can be performed normally only when m=n is satisfied, that is, when the number of pixels is equal in the vertical direction and the horizontal direction. If switching between the display in the vertical direction and the display in the horizontal direction is performed in a display device having different numbers of pixels in the vertical direction and the horizontal direction, format conversion is required.

As shown in FIG. 4B[i], video signals are written to pixels of n rows such as the first to m-th pixel of the first row, the first to m-th pixel of the second row, . . . . In this case, the video signals correspond to m horizontal×n vertical pixels. In order to switch between the display in the vertical direction and the display in the horizontal direction, the video signals are required to be changed to correspond to n horizontal×m vertical pixels as shown in FIG. 4B[ii], which is called format conversion. The format conversion may be performed by a known method; therefore, the description thereof is omitted.

In recent years, a small portable terminal such as a mobile phone tends to be provided with various kinds of software, so that the application of one apparatus becomes wide. Accordingly, it is important to adopt the aforementioned technology for switching between the display in the vertical direction and the display in the horizontal direction. If data is switched between the vertical direction and the horizontal direction using the frame memory as described above, however, there is a problem in that images are displayed discontinuously and noise occurs easily.

In view of the foregoing, the inventor provided a display device for switching between the display in the vertical direction and the display in the horizontal direction without using a frame memory. The display device has a source signal line driver circuit, a first gate signal line driver circuit and a second gate signal line driver circuit. The scanning direction of the second gate signal line driver circuit is perpendicular to that of the first gate signal line driver circuit.

The scanning direction means the direction perpendicular to signal lines controlled by the respective driver circuits. A normal display is referred to as a first display while a display in the case of switching the screen between the vertical direction and the horizontal direction is referred to as a second display.

In the normal display, the first gate signal line driver circuit performs the vertical scanning of the screen and images are displayed in the scanning direction of the first gate signal line. On the other hand, in the second display, the second gate signal line driver circuit performs the vertical scanning of the screen and images are displayed in the scanning direction of the second gate signal line. Such a display device is described in detail in Patent Document 1.
Patent Document 1: Japanese Patent Laid-Open No. 2003-76315

The aforementioned Patent Document 1 discloses a display device capable of switching between the display in the vertical direction and the display in the horizontal direction without adding a frame memory and the like.

However, the aforementioned display device capable of switching between the display in the vertical direction and the display in the horizontal direction has the following problem. The display device requires more signal lines than the conventional display device, which results in decrease in the aperture ratio of a pixel. As shown in FIG. 19, a pixel includes three pixel electrodes of red (R), green (G) and blue (B). With the increase in source signal lines, the pixel becomes vertically longer and the aperture ratio decreases. In FIG. 19, the pixel has source signal lines 1901, 1902 and 1903 for RGB, a first gate signal line 1907, second gate signal lines 1904, 1905 and 1906 for RGB, pixel electrodes 1908, 1909 and 1910 for RGB, and pixel transistors 1911, 1912 and 1913 for RGB. In the pixel having such a configuration, more second gate signal lines are used than in a normal liquid crystal pixel, leading to decrease in the aperture ratio.

### SUMMARY OF THE INVENTION

A display device of the invention has a source signal line driver circuit, a first gate signal line driver circuit and a second gate signal line driver circuit. The scanning direction of the second gate signal line driver circuit is perpendicular to that of the first gate signal line driver circuit.

In a first display, the first gate signal line driver circuit performs vertical scanning of a screen and images are displayed in the scanning direction of a first gate signal line. On the other hand, in a second display, the second gate signal line driver circuit performs the vertical scanning of the screen and images are displayed in the scanning direction of a second gate signal line. In addition, a pixel is driven by a field sequential method. In the field sequential method, one frame period is divided into three subframe periods, during each of which RGB lights are emitted separately so that a color display is performed in one pixel.

According to one mode of the invention, a display device has a light source that periodically changes its emission color, a source signal line driver circuit, a first gate signal line driver circuit, a second gate signal line driver circuit, and a plurality of pixels. The scanning direction of the first gate signal line driver circuit is perpendicular to that of the second gate signal line driver circuit.

According to another mode of the invention, a display device has a light source that periodically changes its emission color, a source signal line driver circuit, a first gate signal line driver circuit, a second gate signal line driver circuit, and a plurality of pixels. Each of the plurality of pixels has a source signal line, a first gate signal line, a second gate signal line that is perpendicular to the first gate signal line, a first transistor, and a second transistor. A gate electrode of the first transistor is electrically connected to the first gate signal line, and an input electrode thereof is electrically connected to the source signal line while an output electrode is electrically connected to an input electrode of the second transistor. A gate electrode of the second transistor is electrically connected to the second gate signal line.

In the aforementioned display device, it is preferable that in a first display, the driving frequency of the source signal line driver circuit be higher than that of the first gate signal line driver circuit while in a second display, the driving frequency of the source signal line driver circuit be lower than that of the first gate signal line driver circuit.

According to another mode of the invention, a display device has a light source that periodically changes its emission color, a first source signal line driver circuit, a second source signal line driver circuit, a first gate signal line driver circuit, a second gate signal line driver circuit, and a plurality of pixels. The first source signal line driver circuit, the second source signal line driver circuit, the first gate signal line driver circuit, the second gate signal line driver circuit, and the plurality of pixels are formed over the same substrate. The scanning direction of the first gate signal line driver circuit is perpendicular to that of the second gate signal line driver circuit.

According to another mode of the invention, a display device has a light source that periodically changes its emission color, a first source signal line driver circuit, a second source signal line driver circuit, a first gate signal line driver circuit, a second gate signal line driver circuit, and a plurality of pixels. Each of the plurality of pixels has a first source signal line, a second source signal line, a first gate signal line, a second gate signal line that is perpendicular to the first gate signal line, a first transistor, and a second transistor. A gate electrode of the first transistor is electrically connected to the first gate signal line, and an input electrode thereof is electrically connected to the first source signal line. A gate electrode of the second transistor is electrically connected to the second gate signal line, and an input electrode thereof is electrically connected to the second source signal line.

In the aforementioned display device, it is preferable that in a first display, an image be displayed in the scanning direction of the first gate signal line driver circuit while in a second display, an image be displayed in the scanning direction of the second gate signal line driver circuit.

In the aforementioned display device, it is preferable that at least one of the signal line driver circuits and the plurality of pixels be formed over the same substrate.

In the aforementioned display device, each of the plurality of pixels may have a liquid crystal element.

According to another mode of the invention, a driving method of a display device having a source signal line driver circuit, a first gate signal line driver circuit, a second gate signal line driver circuit, and a plurality of pixels, wherein the scanning direction of the first gate signal line driver circuit is perpendicular to that of the second gate signal line driver circuit, has the step of driving the plurality of pixels by a field sequential method.

According to another mode of the invention, a driving method of a display device having a source signal line driver circuit, a first gate signal line driver circuit, a second gate signal line driver circuit, and a plurality of pixels, wherein each of the plurality of pixels has a source signal line, a first gate signal line, a second gate signal line that is perpendicular to the first gate signal line, a first transistor, and a second transistor, a gate electrode of the first transistor is electrically connected to the first gate signal line and an input electrode thereof is electrically connected to the source signal line while an output electrode is electrically connected to an input electrode of the second transistor, and a gate electrode of the second transistor is electrically connected to the second gate signal line, has the step of driving the plurality of pixels by a field sequential method.

In the aforementioned driving method, it is preferable that in a first display, the driving frequency of the source signal line driver circuit be higher than that of the first gate signal line driver circuit while in a second display, the driving frequency of the source signal line driver circuit be lower than that of the first gate signal line driver circuit.

According to another mode of the invention, a driving method of a display device having a first source signal line driver circuit, a second source signal line driver circuit, a first gate signal line driver circuit, a second gate signal line driver circuit, and a plurality of pixels, wherein the scanning direction of the first gate signal line driver circuit is perpendicular to that of the second gate signal line driver circuit, has the step of driving the plurality of pixels by a field sequential method.

According to another mode of the invention, a driving method of a display device having a first source signal line driver circuit, a second source signal line driver circuit, a first gate signal line driver circuit, a second gate signal line driver circuit, and a plurality of pixels, wherein each of the plurality of pixels has a first source signal line, a second source signal line, a first gate signal line, a second gate signal line that is perpendicular to the first gate signal line, a first transistor, and a second transistor, a gate electrode of the first transistor is electrically connected to the first gate signal line while an input electrode thereof is electrically connected to the first source signal line, and a gate electrode of the second transistor is electrically connected to the second gate signal line while an input electrode thereof is electrically connected to the second source signal line, has the step of driving the plurality of pixels by a field sequential method.

In the aforementioned driving method, it is preferable that in a first display, an image be displayed in the scanning direction of the first gate signal line driver circuit while in a second display, an image be displayed in the scanning direction of the second gate signal line driver circuit.

According to the invention, a screen can be easily switched between the vertical direction and the horizontal direction and the aperture ratio can be improved, leading to a display device with high image quality.

### BRIEF DESCRIPTION OF THE DRAWINGS

FIGS. 1A and 1B are diagrams showing one embodiment mode of the invention.

FIGS. 2A to 2C are schematic diagrams showing a display device conventionally used.

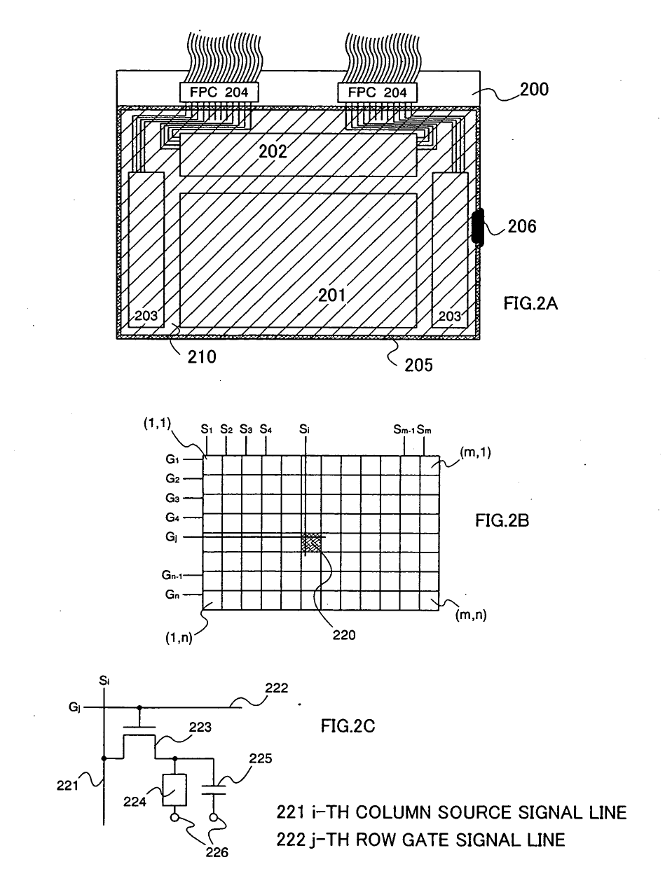

FIGS. 3A and 3B are diagrams showing the switching between the display in the vertical direction and the display in the horizontal direction.

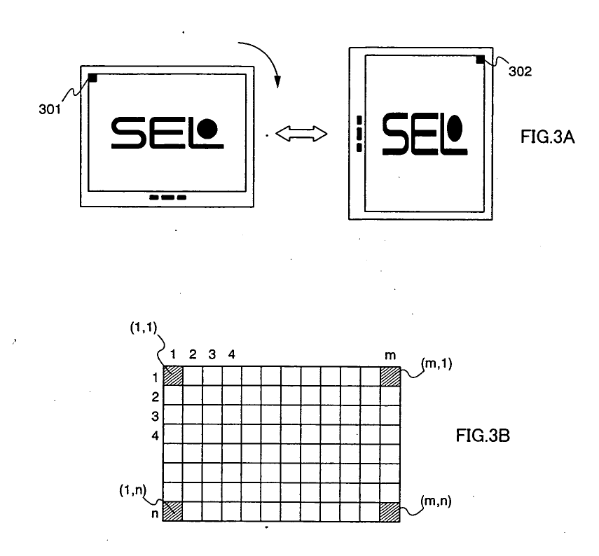

FIG. 4A is a flow chart showing the switching between the display in the vertical direction and the display in the horizontal direction using a frame memory, and FIG. 4B is a diagram showing format conversion.

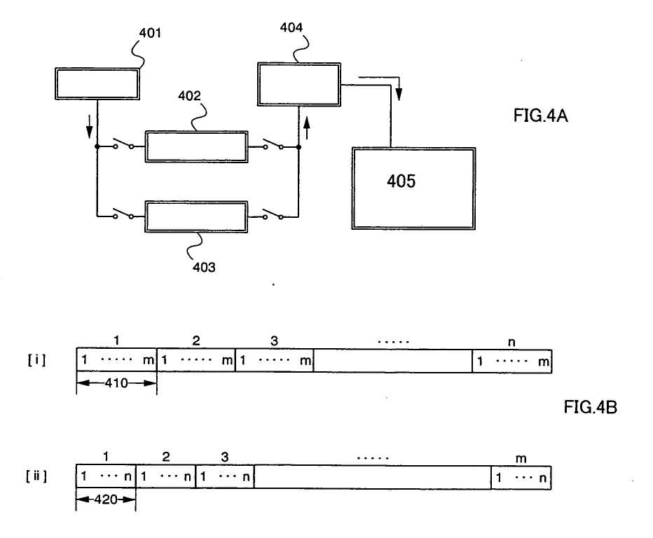

FIGS. 5A to 5C are diagrams showing the timing for driving a display device.

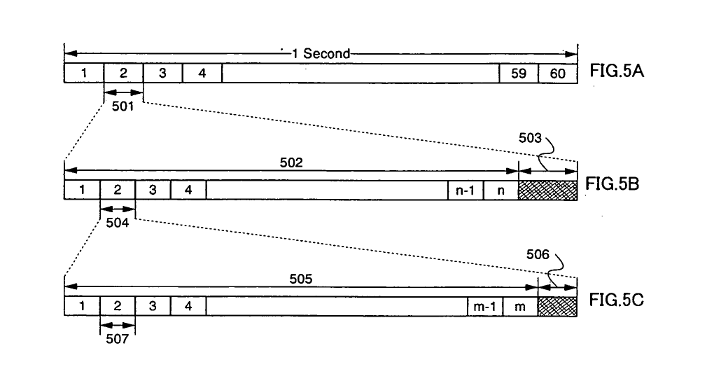

FIG. 6A is a diagram showing a configuration of a source signal line driver circuit, and FIG. 6B is a timing chart thereof.

FIG. 7A is a diagram showing a configuration of a gate signal line driver circuit, and FIG. 7B is a timing chart thereof.

FIGS. 8A and 8B are diagrams showing the order of writing video signals in the case of a normal display and a display switched between the vertical direction and the horizontal direction, respectively.

FIG. 9 is a diagram showing a configuration of a gate signal line driver circuit having a scanning direction switching circuit.

FIGS. 10A to 10C are diagrams showing the timing for driving a display device in the case of switching between the display in the vertical direction and the display in the horizontal direction.

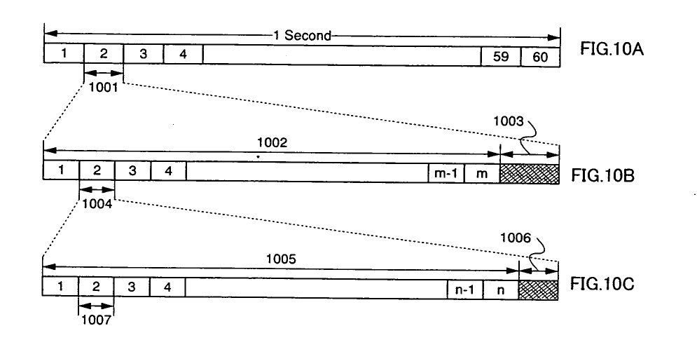

FIG. 11 is a diagram showing a configuration of OCB liquid crystal.

FIGS. 12A and 12B are diagrams showing a configuration of a display device having two independent driver circuits, which is one embodiment of the invention.

FIGS. 13A to 13C are diagrams showing examples of an electronic apparatus to which the invention can be applied.

FIG. 14 is a diagram showing a configuration of a source signal line driver circuit performing a division driving.

FIGS. 15A to 15D are diagrams showing a display and the order of inputting video signals in the case of adopting the invention in a display device performing a division driving.

FIGS. 16A to 16D are diagrams showing an example of manufacturing steps of an active matrix liquid crystal display device.

FIGS. 17A to 17D are diagrams showing an example of manufacturing steps of an active matrix liquid crystal display device.

FIG. 18 is a diagram showing an example of a manufacturing step of an active matrix liquid crystal display device.

FIG. 19 is a diagram showing a pixel in the case of not using a field sequential method.

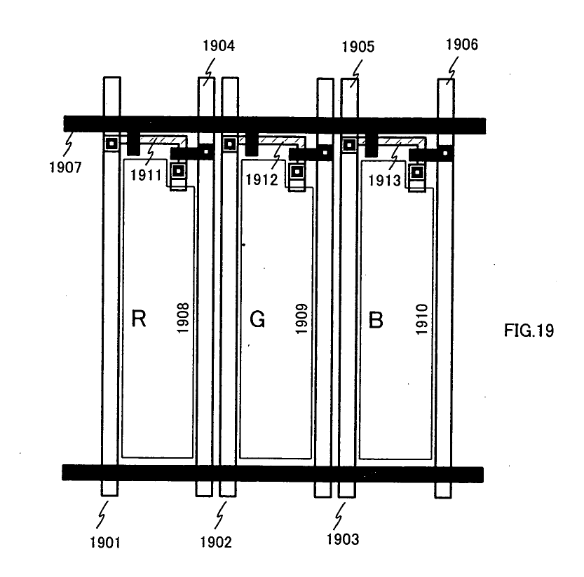

FIG. 20 is a diagram showing a pixel in the case of using a field sequential method.

FIG. 21 is a diagram showing the timing of a field sequential method.

FIGS. 22A and 22B are diagrams showing one mode of a liquid crystal display device.

FIG. 23 is a diagram showing one mode of a mobile phone including a liquid crystal display device.

FIGS. 24A and 24B are diagrams showing one mode of a mobile phone.

### DETAILED DESCRIPTION OF THE INVENTION

Although the invention will be described by way of Embodiment Mode and Embodiments with reference to the accompanying drawings, it is to be understood that various changes and modifications will be apparent to those skilled in the art. Therefore, unless such changes and modifications depart from the scope of the invention, they should be construed as being included therein.

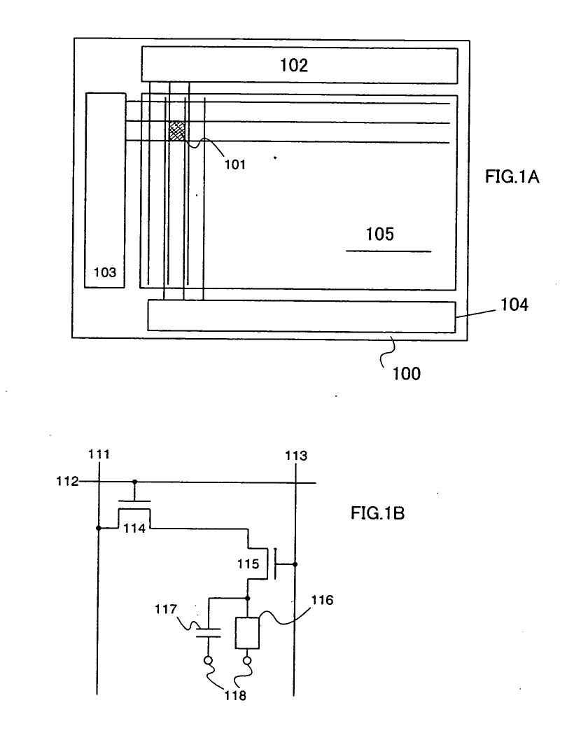

FIG. 1A shows one embodiment mode of the invention. A pixel portion 105, a source signal line driver circuit 102, a first gate signal line driver circuit 103, and a second gate signal line driver circuit 104 are formed over a substrate 100.

In the pixel portion 105, one pixel 101 is formed in an area surrounded by signal lines extending from the first gate signal line driver circuit 103, the second gate signal line driver circuit 104 and the source signal line driver circuit 102. A circuit configuration of the pixel 101 is shown in FIG. 1B. The pixel 101 has a source signal line 111, a first gate signal line 112, a second gate signal line 113, a first pixel TFT 114, a second pixel TFT 115, a liquid crystal element 116, a storage capacitor 117, and an opposite electrode 118.

A gate electrode of the first pixel TFT 114 is electrically connected to the first gate signal line 112 and on/off controlled by a pulse inputted to the first gate signal line 112. A gate electrode of the second pixel TFT 115 is electrically connected to the second gate signal line 113 and on/off controlled by a pulse inputted to the second gate signal line 113.

When both of the first pixel TFT 114 and the second pixel TFT 115 are on, a video signal inputted from the source signal line 111 is inputted to the pixel and charge is held in the storage capacitor 117.

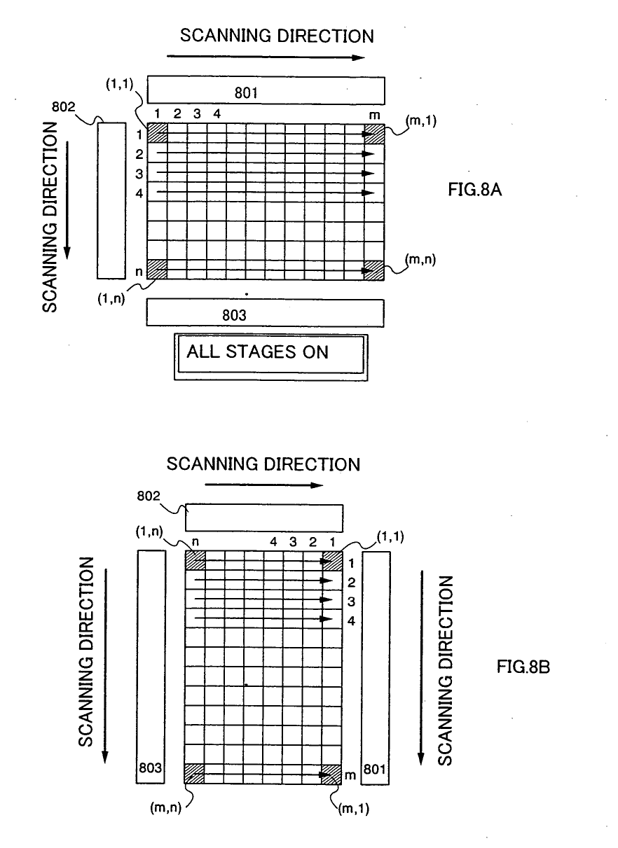

Operation of the circuit is described. Note that the format conversion of video signals may be performed by any method; therefore, in this embodiment mode, the case where the number of pixels is m×n and m=n is satisfied so as not to require the format conversion is taken as an example for simplicity. Explanation is made with reference to FIGS. 1A and 1B and FIGS. 8A and 8B.

In a first display, namely in a normal display, the second gate signal line driver circuit 104 controls the second pixel TFTs 115 of the entire screen to be turned on. Accordingly, the pixel is controlled only by on/off of the first pixel TFT 114. The source signal line driver circuit and the first gate signal line driver circuit are driven in the same manner as the conventional ones, thereby images are displayed. As shown in FIG. 8A, writing to pixels is performed in the order of (1, 1), (2, 1), . . . , (m, 1), (1, 2), (2, 2), . . . , (m, 2), . . . , (1, n), (2, n), and (m, n).

Described next is a second display, namely the case of switching the screen between the vertical direction and the horizontal direction. FIG. 8B shows the state after the screen shown in FIG. 8A is rotated by 90° clockwise. Since the display device of the invention does not use a frame memory, the order of inputting video signals does not change. Thus, writing to pixels in FIG. 8B is performed in the order of (1, n), (1, n−1), . . . , (1, 1), (2, n), (2, n−1), . . . , (2, 1), (m, n), (m, n−1), . . . , and (m, 1).

Accordingly, in the second display, the source signal line driver circuit 801 is driven at a lower rate than usual and outputs sampling pulses for each one horizontal period. As a result, a sampling switch is opened during one horizontal period, and thus video signals for one horizontal period are continuously written to one source signal line. On the other hand, the first gate signal line driver circuit 802 is driven at a higher rate than usual and outputs gate signal line selection pulses for each one dot sampling period. As a result, the first pixel TFT in each pixel is on only during one dot sampling period and a video signal at this time is written. The second gate signal line driver circuit 803 operates in the same manner as the source signal line driver circuit 801. That is to say, when a sampling pulse is outputted from the source signal line driver circuit 801 and a video signal is inputted to the source signal line of a certain column, the second gate signal line of the column is selected and all the second pixel TFTs connected to the selected second gate signal line are turned on. Thus, video signals can be written only to the pixels of that column.

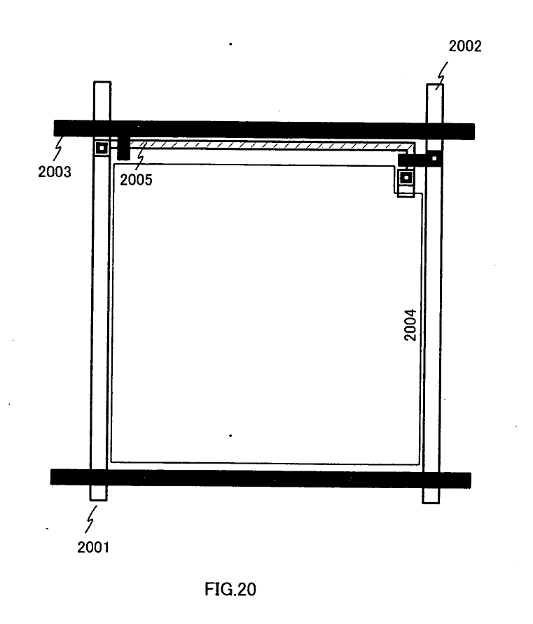

FIG. 20 is a plan view of a pixel according to the invention. Since a field sequential method is adopted, it is not necessary to divide a pixel into RGB. Therefore, a smaller number of signal lines are needed and the opening ratio can be significantly improved. The pixel shown in FIG. 20 has a source signal line 2001, a first gate signal line 2003, a second gate signal line 2002, a pixel electrode 2004, and a pixel TFT 2005.

An embodiment mode of the field sequential method is described next. The field sequential method is performed using a light source that periodically changes its emission color and a light shutter such as liquid crystal to perform a color display. As the light source that periodically changes its emission color, RGB cold cathode tubes or LEDs are used while being switched to emit light. Alternatively, a color filter may be rotated in front of a white light source to extract RGB components separately. A mobile apparatus and the like preferably employ RGB LEDs that are switched to emit light.

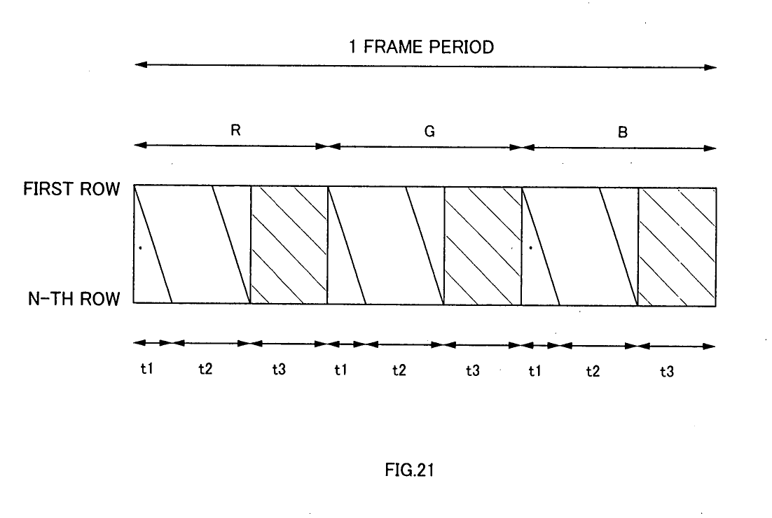

Generally in a television image and the like, one frame period is about 16.6 ms. When one frame period is divided into three subframe periods for RGB, one subframe period is about 5.53 ms. In practice, each lighting period of RGB is desirably about 2 ms in view of a writing period to a pixel, response speed of liquid crystal, and the like. FIG. 21 is a timing chart, and operation thereof is described below. In this embodiment mode, RGB images are displayed in this order for convenience. First, R data is written to pixels, to which liquid crystal responds. When the writing and the response of the liquid crystal are completed, an R light source emits light. After emitting light during a predetermined period, the R light source is turned off. In FIG. 21, t1 denotes a period from the start of writing to pixels of the first row to the end of writing to pixels of the n-th row. The response time of the liquid crystal is denoted by t2. The lighting time of the light source (such as LED) is denoted by t3.

Then, G data is written to pixels, to which liquid crystal responds. When the writing and the response of the liquid crystal are completed, a G light source emits light. After emitting light during a predetermined period, the G light source is turned off. Further, B data is written to pixels, to which liquid crystal responds. When the writing and the response of the liquid crystal are completed, a B light source emits light. After emitting light during a predetermined period, the B light source is turned off.

By repeating this operation, the field sequential method is achieved. High speed liquid crystal is required for the field sequential method. In the invention, liquid crystal materials such as OCB (Optically Compensated Bend), FLC (Ferroelectric Liquid Crystal), and AFLC (Anti-Ferroelectric Liquid Crystal) may be used, though the invention is not limited to these. The invention may also be implemented using TN (Twist Nematic) liquid crystal by decreasing the cell gap or using a transient state.

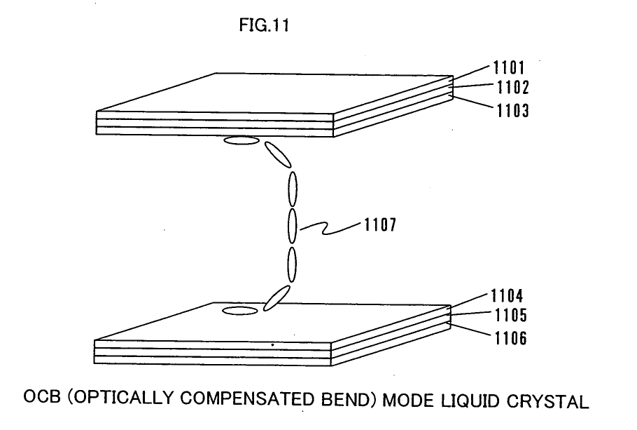

FIG. 11 shows an example of OCB liquid crystal. The OCB liquid crystal is a liquid crystal material providing a wide viewing angle and fast response; therefore, it is suitable for the field sequential method. Retardation films 1102 and 1105 and polarizers 1101 and 1106 are attached to substrates 1103 and 1104 respectively. A liquid crystal material 1107 is sandwiched between the substrates 1103 and 1104. The OCB liquid crystal has symmetric bend alignment, and the top layer portion and the bottom layer portion of the cell compensate for each other. A wide viewing angle can be achieved by combining the retardation films 1102 and 1105 with a hybrid discotic film with an angle of inclination that changes depending on the alignment of a liquid crystal layer.

### EMBODIMENT 1

In the case of switching between the display in the vertical direction and the display in the horizontal direction in the manner shown in Embodiment Mode, the scanning direction of the first gate signal line driver circuit is focused on. In the normal display, as shown in FIG. 8A, the first gate signal line driver circuit sequentially selects and scans gate signal lines from the first row to the n-th row. Meanwhile, when the screen is switched between the vertical direction and the horizontal direction, as shown in FIG. 8B, the first gate signal line driver circuit sequentially selects and scans gate signal lines from the n-th row to the first row. Thus, when switching between the display in the vertical direction and the display in the horizontal direction, the scanning direction of the first gate signal line driver circuit is required to be changed.

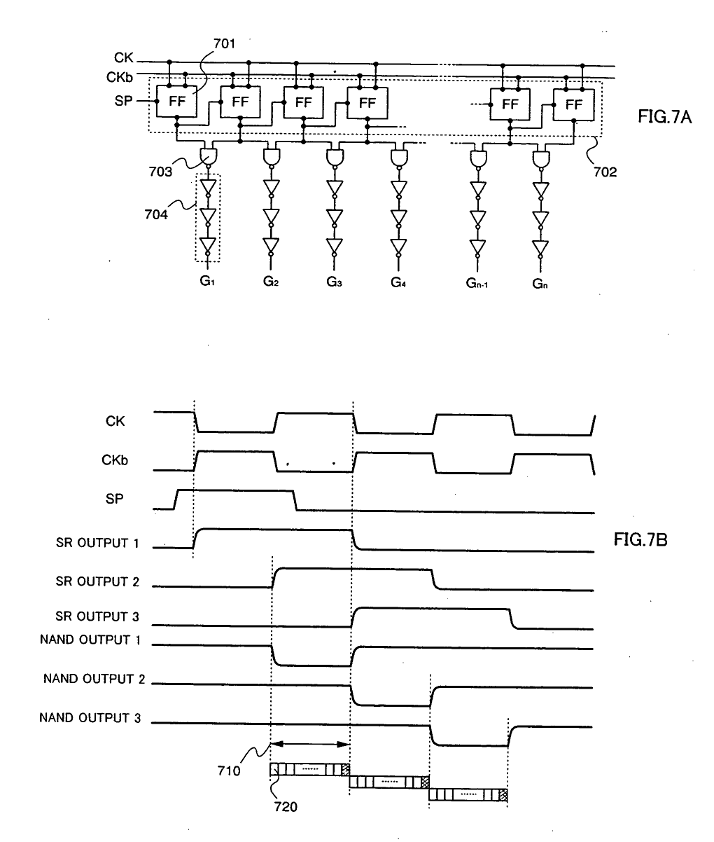

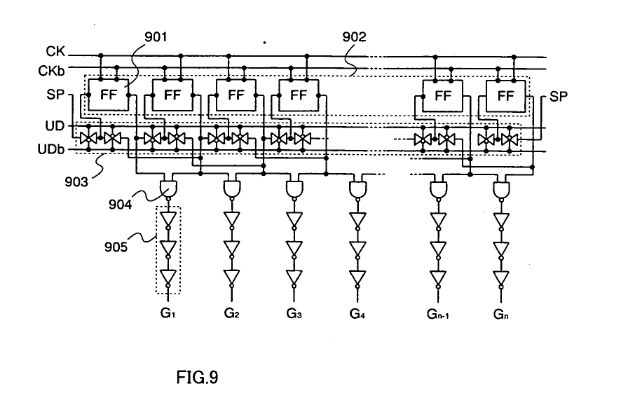

FIG. 9 shows a configuration of a driver circuit added with a scanning direction switching circuit. A shift register 902 including a plurality of stages of flip flops 901, a NAND 904 and a buffer 905 are the same as those of the conventional driver circuit shown in FIG. 7A. A scanning direction switching signal (UD) and a scanning direction switching inverted signal (UDb) are inputted to a scanning direction switching circuit 903. When the scanning direction switching signal (UD) is at H and the scanning direction switching inverted signal (UDb) is at L gate signal lines are selected in the order of G₁, G₂, . . . , and Gₙ. When the scanning direction switching signal (UD) is at L and the scanning direction switching inverted signal (UDb) is at H, gate signal lines are selected in the order of Gₙ, Gₙ₋₁, . . . , and G₁.

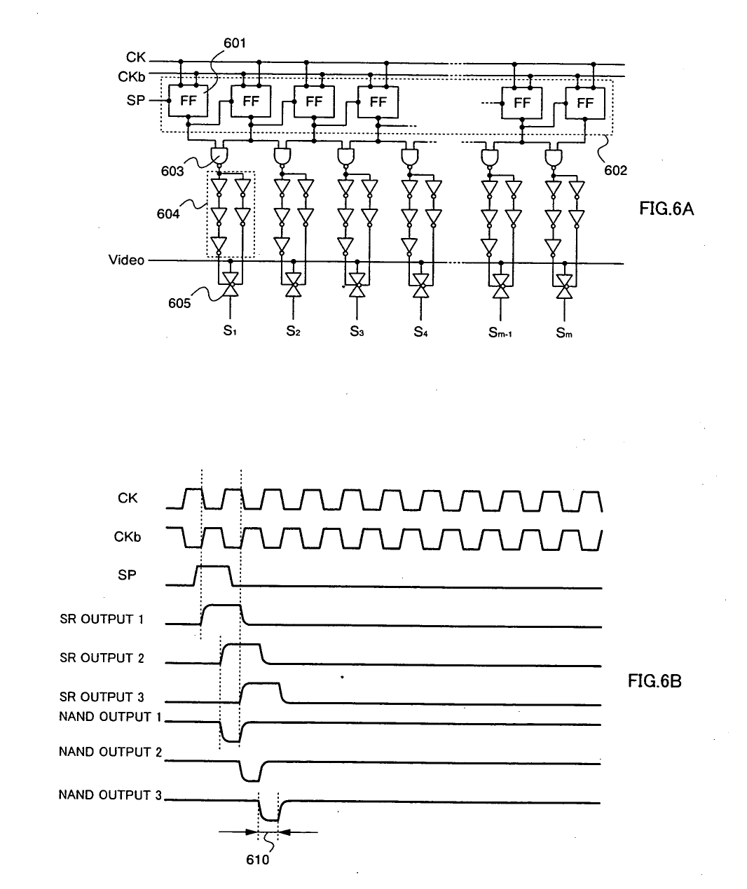

Note that the configuration of the driver circuit is not limited to those shown in FIGS. 6A and 6B, FIGS. 7A and 7B, FIG. 9 and the like. The invention may also be implemented using, for example, a decoder instead of the shift register.

### EMBODIMENT 2

This embodiment shows an example of easily switching between the display in the vertical direction and the display in the horizontal direction in a different manner than Embodiment Mode.

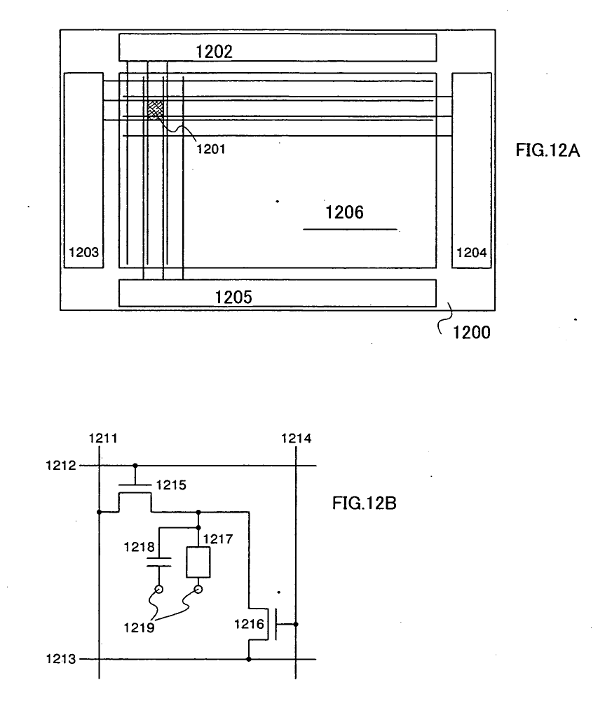

FIG. 12A shows a configuration of a display device. A pixel portion 1206 is formed over a substrate 1200. In addition, a first source signal line driver circuit 1202, a first gate signal line driver circuit 1203, a second source signal line driver circuit 1204, and a second gate signal line driver circuit 1205 are formed over the substrate 1200. In this configuration, the scanning direction of the first source signal line driver circuit is perpendicular to that of the second source signal line driver circuit. Similarly, the scanning direction of the first gate signal line driver circuit is perpendicular to that of the second gate signal line driver circuit.

Reference numeral 1201 denotes one pixel in the pixel portion 1206, the configuration of which is shown in FIG. 12B. The pixel has a first source signal line 1211, a first gate signal line 1212, a second source signal line 1213, a second gate signal line 1214, a first pixel TFT 1215, a second pixel TFT 1216, a liquid crystal element 1217, a storage capacitor 1218, and an opposite electrode 1219.

Since the pixel according to this embodiment includes the two source signal lines, the two gate signal lines and the two pixel TFTs, a video signal can be written to the liquid crystal element through two independent pathways. In a first display, namely in a normal display, for example, the first pixel TFT is controlled by operating the first source signal line driver circuit and the first gate signal line driver circuit, thereby a video signal inputted to the first source signal line 1211 is written to the pixel. At this time, neither the second source signal line driver circuit nor the second gate signal line driver circuit is driven.

On the other hand, in a second display, namely in the case of switching the screen between the vertical direction and the horizontal direction, the second pixel TFT is controlled by operating the second source signal line driver circuit and the second gate signal line driver circuit, thereby a video signal inputted to the second source signal line 1213 is written to the pixel. At this time, neither the first source signal line driver circuit nor the first gate signal line driver circuit is driven.

The switching between the display in the vertical direction and the display in the horizontal direction can be facilitated by thus controlling one pixel using two pairs of driver circuits alternately.

### EMBODIMENT 3

In a display device with a large screen and high resolution, it is necessary to drive as many pixels as possible during a predetermined period. The driving frequency increases according to the conventional driving method; therefore, a division driving is adopted in many cases.

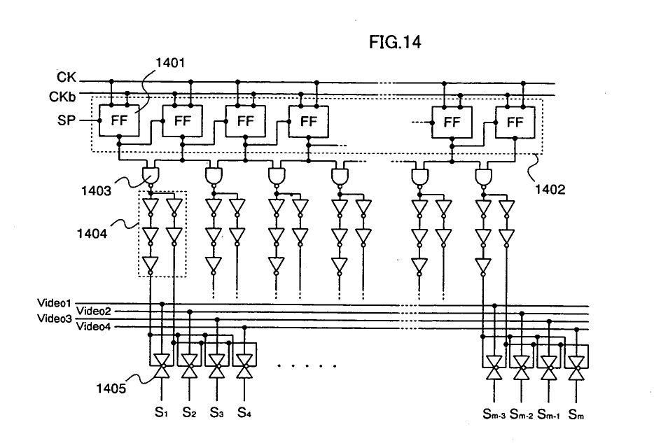

FIG. 14 shows a configuration example of a source signal line driver circuit in the case of performing the division driving, which has a shift register 1402 including a plurality of stages of flip flops 1401, a NAND 1403, a buffer 1404, a sampling switch 1405, and the like.

A video signal is written to one pixel by one sampling pulse in the circuit shown in FIG. 6A. Meanwhile, in the circuit shown in FIG. 14, four video signals are inputted in parallel and video signals are simultaneously written to four pixels by one sampling pulse. According to this, the driving frequency of the source signal line driver circuit can be reduced to 1/the number of divisions as compared to the conventional display device having the same number of pixels. In the case of FIG. 14, the sampling is performed for four pixels at a time, that is, the number of divisions is four; therefore, the driving frequency of the source signal line driver circuit can be reduced to ¼.

Described in this embodiment is a method of switching between the display in the vertical direction and the display in the horizontal direction in a display device performing such a division driving.

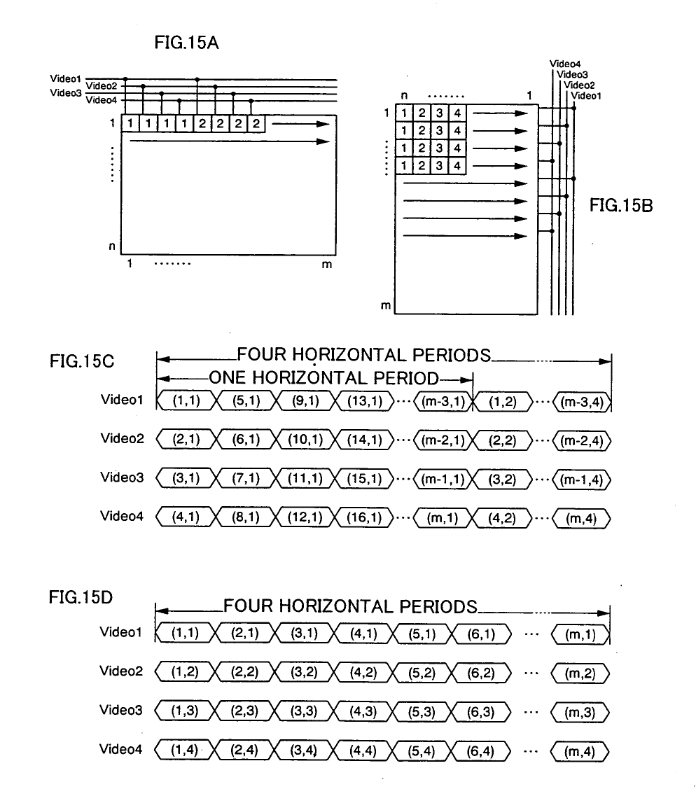

Explanation is made with reference to FIGS. 15A to 15D. FIG. 15A shows the order of writing to pixels in a normal display in a display device having a source signal line driver circuit performing the four-division driving. The sampling is performed for four pixels at a time by four video signal lines, and video signals are simultaneously written to four pixels (1, 1), (2, 1), (3, 1) and (4, 1) by the first sampling pulse. Subsequently, video signals are simultaneously written to four pixels (5, 1), (6, 1), (7, 1) and (8, 1) by the next sampling pulse.

As a result, video signals are inputted to each video signal line (Video1 to Video4) in the order shown in FIG. 15C.

FIG. 15B shows the order of writing to pixels in the case where the display device shown in FIG. 15A is switched between the display in the vertical direction and the display in the horizontal direction. While the sampling is performed for four pixels arranged in the horizontal direction in the normal display, the sampling is performed for four pixels arranged in the vertical direction in the case of switching the display direction.

In the normal display, video signals are simultaneously written to the four pixels (1, 1), (2, 1), (3, 1) and (4, 1) by the first sampling pulse. Meanwhile, when switching the display direction, video signals are simultaneously written to four pixels (1, n), (2, n), (3, n) and (4, n) by the first sampling pulse.

The video signals written to the four pixels at this time are video signals that are to be written to the pixels (1, 1), (1, 2), (1, 3) and (1, 4) in the normal display.

As a result, in the case of switching between the display in the vertical direction and the display in the horizontal direction, video signals are inputted to each video signal line (Video1 to Video4) in the order shown in FIG. 15D.

In that case, a memory for storing video signals for four horizontal periods is required since it is necessary to rearrange video signals for four horizontal periods. However, a much smaller amount of storage capacitance is required as compared to the conventional display device using a frame memory.

In this manner, the invention can be implemented in the display device performing the division driving.

### EMBODIMENT 4

Described in this embodiment is a method of simultaneously manufacturing a pixel portion and TFTs (an N-channel TFT and a P-channel TFT) of a driver circuit provided at the periphery of the pixel portion over the same substrate.

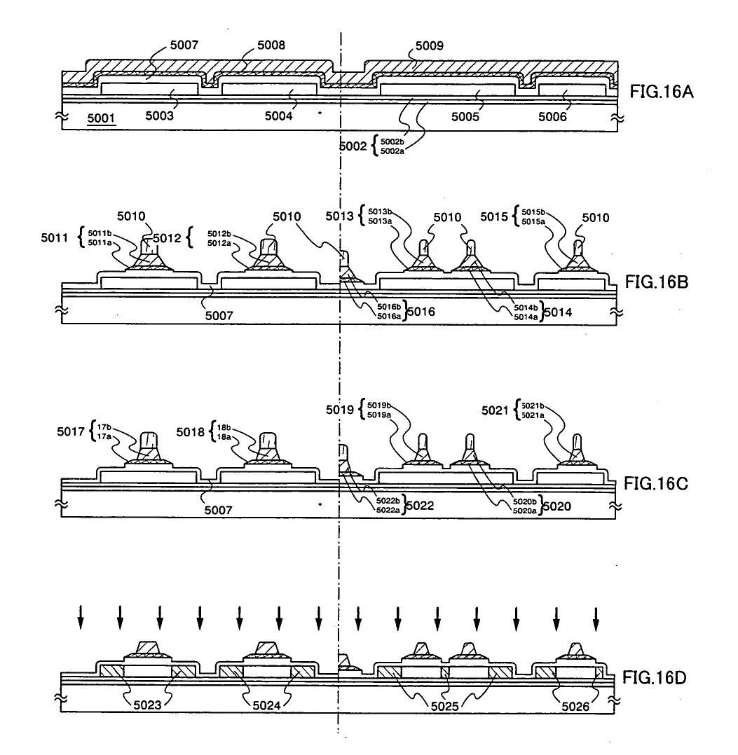

Explanation is made with reference to FIGS. 16A to 16D. First, a base insulating film 5002 is formed over a substrate 5001. Then, a first semiconductor film having a crystalline structure is formed and etched to be a desired shape, thereby semiconductor layers 5003 to 5006 each having an isolated island shape are formed.

In this embodiment, a glass substrate (#1737 substrate) is used as the substrate 5001. As the base insulating film 5002, a silicon oxynitride film 5002a (composition ratio of Si=32%, O=27%, N=24%, and H=17%) with a thickness of 50 nm (preferably, 10 to 200 nm) is formed by plasma CVD at a deposition temperature of 400° C. using SiH₄, NH₃ and N₂O as material gases. After the surface of the silicon oxynitride film 5002a is washed with ozonated water, an oxide film on the surface is removed with dilute hydrofluoric acid (1/100 dilution). Subsequently, a hydrogenated silicon oxynitride film 5002b (composition ratio of Si=32%, O=59%, N=7%, and H=2%) with a thickness of 100 nm (preferably, 50 to 200 nm) is formed on the silicon oxynitride film 5002a by plasma CVD at a deposition temperature of 400° C. using SiH₄ and N₂O as material gases. Further, without being exposed to the atmosphere, a semiconductor film having an amorphous structure (an amorphous silicon film herein) with a thickness of 54 nm (preferably, 25 to 80 nm) is formed by plasma CVD at a deposition temperature of 300° C. using SiH₄ as a deposition gas.

Although the base insulating film 5002 has a two-layer structure in this embodiment, a single layer structure or a three or more layer structure of the aforementioned insulating film may be employed as well. A material of the semiconductor film is not specifically limited, though the semiconductor film is preferably formed by a known method (sputtering, LPCVD, plasma CVD or the like) using silicon, a silicon-germanium alloy (SiₓGe₁₋ₓ (x=0.0001 to 0.02)) or the like. The plasma CVD apparatus may be a single wafer system or a batch system. Alternatively, the base insulating film and the semiconductor film may be continuously formed in the same deposition chamber without being exposed to the atmosphere.

After the surface of the semiconductor film having an amorphous structure is washed, an ultra-thin oxide film (not shown) with a thickness of about 2 nm is formed with ozonated water. Then, a small amount of impurity element (boron or phosphorous) is added to control the threshold value of the TFT. In this embodiment, ion doping in which plasma is excited is used without performing mass separation on diborane (B₂H₆), and boron is added to the amorphous silicon film under the doping conditions that the accelerating voltage is 15 kV, the flow rate of gas in which diborane is diluted with hydrogen to 1% is 30 sccm, and the dosage is 2×10¹² atoms/cm².

A nickel acetate solution containing nickel of 10 ppm by weight is applied by a spinner. A nickel element may be sprayed over the entire surface by sputtering instead of spin coating.

Heat treatment is performed to crystallize the amorphous silicon film and form a semiconductor film having a crystalline structure. The heat treatment is achieved in an electric furnace or by irradiation of intense light. When the heat treatment in an electric furnace is adopted, it may be performed at a temperature of 500 to 650° C. for 4 to 24 hours. In this embodiment, a silicon film having a crystalline structure is obtained by heat treatment for crystallization (at 550° C. for 4 hours) after heat treatment for dehydrogenation (at 500° C. for 1 hour). Although the crystallization is performed by the heat treatment using an electric furnace in this embodiment, it may be performed by a lamp annealing apparatus. In addition, although this embodiment uses a crystallization method where nickel is used as a metal element for accelerating crystallization of silicon, other known crystallization methods such as solid phase growth and laser crystallization may be employed as well.

After the oxide film on the surface of the silicon film having a crystalline structure is removed with dilute hydrofluoric acid or the like, irradiation of the first laser light (XeCl: wavelength of 308 nm) is performed in the atmosphere or in the presence of oxygen to increase the crystallization rate and correct defects remaining in crystal grains. Excimer laser light with a wavelength of 400 nm or less, second harmonic wave or third harmonic wave of a YAG laser, or a CW laser is used as the laser light. In either case, pulse laser light with a repetition rate of about 10 to 1000 Hz is used, the pulse laser light is condensed to 100 to 500 mJ/cm² by an optical system, and irradiation is performed with an overlap ratio of 90 to 95%, thereby the silicon film surface may be scanned. In this embodiment, irradiation of the first laser light is performed in the atmosphere with a repetition rate of 30 Hz and energy density of 393 mJ/cm². Note that an oxide film is formed on the surface since the irradiation of the first laser light is performed in the atmosphere or in the presence of oxygen.

After the oxide film formed by the irradiation of the first laser light is removed with dilute hydrofluoric acid, irradiation of the second laser light is performed in the presence of nitrogen or in vacuum to smooth the surface of the semiconductor film. Excimer laser light with a wavelength of 400 nm or less, second harmonic wave or third harmonic wave of a YAG laser, or a CW laser is used as the second laser light. The energy density of the second laser light is set to be higher than that of the first laser light (preferably, higher by 30 to 60 mJ/cm²). In this embodiment, irradiation of the second laser light is performed with a repetition rate of 30 Hz and energy density of 453 mJ/cm², so that the P-V value of the unevenness of the surface of the semiconductor film is 5 nm or less.

Although the entire surface is irradiated with the second laser light in this embodiment, only the pixel portion may be selectively irradiated with the laser light since reduction in off current is particularly effective for the TFT in the pixel portion. Further, the laser irradiation may be performed only once.

The surface is treated with ozonated water for 120 seconds, thereby a barrier layer (not shown) formed of oxide films with a total thickness of 1 to 5 nm is formed.

An amorphous silicon film containing argon with a thickness of 150 nm is formed over the barrier layer by sputtering to act as a gettering site. In this embodiment, the sputtering is performed under the deposition conditions that the deposition pressure is 0.3 Pa, the flow rate of gas (Ar) is 50 sccm, the deposition power is 3 kW, and the temperature of substrate is 150° C. Note that the atomic concentration of argon contained in the amorphous silicon film under the aforementioned conditions is 3×10²⁰ to 6×10²⁰ atoms/cm³, and the atomic concentration of oxygen is 1×10¹⁹ to 3×10¹⁹ atoms/cm³. Subsequently, heat treatment using a lamp annealing apparatus is applied at a temperature of 650° C. for three minutes to perform gettering.

After the amorphous silicon film containing argon, which acts as a gettering site, is selectively removed using the barrier layer as an etching stopper, the barrier layer is selectively removed with dilute hydrofluoric acid. Since nickel tends to move to a region with a high concentration of oxygen in gettering, the barrier layer formed of an oxide film is desirably removed after the gettering.

A thin oxide film is formed with ozonated water on the surface of the obtained silicon film (also called a polysilicon film) having a crystalline structure. Then, a resist mask is formed and etching is performed to obtain a desired shape, thereby the semiconductor layers 5003 to 5006 each having an isolated island shape are formed. After the semiconductor layers are formed, the resist mask is removed.

The surface of the silicon film is washed at the same time as removing the oxide film with an etchant containing hydrofluoric acid. Subsequently, an insulating film mainly containing silicon is formed as a gate insulating film 5007. In this embodiment, a silicon oxynitride film (composition ratio of Si=32%, O=59%, N=7%, and H=2%) with a thickness of 115 nm is formed by plasma CVD.

A first conductive film 5008 with a thickness of 20 to 100 nm and a second conductive film 5009 with a thickness of 100 to 400 nm are stacked over the gate insulating film 5007. In this embodiment, a tantalum nitride (TaN) film with a thickness of 50 nm and a tungsten (W) film with a thickness of 370 nm are formed in this order over the gate insulating film 5007 (FIG. 16A).

As conductive materials of the first conductive film and the second conductive film, an element selected from Ta, W, Ti, Mo, Al, and Cu, or an alloy material or a compound material mainly containing such an element may be employed. Alternatively, the first conductive film and the second conductive film may be formed of a semiconductor film typified by a polycrystalline silicon film doped with an impurity element such as phosphorous, or an AgPdCu alloy film. The conductive film is not limited to a two-layer structure, and it is also possible to adopt, for example, a three-layer structure of a tungsten film with a thickness of 50 nm, an aluminum-silicon alloy (Al—Si) film with a thickness of 500 nm, and a titanium nitride film with a thickness of 30 nm. In the case of the three-layer structure, a tungsten nitride film may be used instead of the tungsten film as the first conductive film, an aluminum-titanium alloy (Al—Ti) film may be used instead of the aluminum-silicon alloy (Al—Si) film as the second conductive film, and a titanium film may be used instead of the titanium nitride film as the third conductive film. Alternatively, a single layer structure may be adopted as well.

Then, as shown in FIG. 16B, a resist mask 5010 is formed by an exposure step, and a first etching step is performed to form a gate electrode and a wiring. The first etching step is performed under first and second etching conditions. It is preferable to use an ICP (Inductively Coupled Plasma) etching method. The film can be etched to a desired tapered shape by using the ICP etching method and controlling the etching conditions (the amount of power applied to a coiled electrode, the amount of power applied to an electrode on the substrate side, the temperature of the electrode on the substrate side, and the like). As an etching gas, a chlorinated gas such as Cl₂, BCl₃, SiCl₄, and CCl₄, a fluorinated gas such as CF₄, SF₆, and NF₃, or O₂ may be employed.

In this embodiment, the substrate side (sample stage) also receives an RF (13.56 MHz) power of 150 W to be applied with a substantially negative self-bias voltage. The W film is etched under the first etching condition so that the edge portion of the first conductive layer has a tapered shape. Under the first etching condition, the etching rate of the W film is 200.39 nm/min, and the etching rate of the TaN film is 80.32 nm/min. The selection ratio of the W film to the TaN film is therefore about 2.5. The W film is tapered under the first etching condition at an angle of about 26°. Then, the first etching condition is changed to the second etching condition without removing the resist mask 5010. Etching is performed for about 30 seconds under the second etching condition that CF₄ and Cl₂ are used as etching gases, the flow rate of each of the gases is 30 sccm, and an RF (13.56 MHz) power of 500 W is applied to the coiled electrode at a pressure of 1.0 Pa to generate plasma. The substrate side (sample stage) also receives an RF (13.56 MHz) power of 20 W to be applied with a substantially negative self-bias voltage. Under the second etching condition using a mixture of CF₄ and Cl₂, the TaN film and the W film are etched to almost the same degree. The etching rate of the W film is 58.97 nm/min, and the etching rate of the TaN film is 66.43 nm/min under the second etching condition. In order to etch the films without leaving any residue on the gate insulating film, the etching time may be increased at a rate of about 10 to 20%.

In the first etching step, the first conductive layer and the second conductive layer are tapered around the edge portions by forming the resist mask into a proper shape and by the effect of the bias voltage applied to the substrate side. The angle of the tapered portions may be set to 15 to 45°.

In this manner, first shape conductive layers 5011 to 5016 including the first conductive layer and the second conductive layer (first conductive layers 5011a to 5016a and second conductive layers 5011b to 5016b) are formed by the first etching step. A region of the insulating film 5007 to serve as a gate insulating film, which is not covered with the first shape conductive layers 5011 to 5016, is etched about 10 to 20 nm to be thin.

Next, a second etching step is performed without removing the resist mask. In this embodiment, etching is performed for 25 seconds under the conditions that SF₆, Cl₂ and O₂ are used as etching gases, the flow rate of the gases is set to 24, 12 and 24 sccm respectively, and an RF (13.56 MHz) power of 700 W is applied to a coiled electrode at a pressure of 1.3 Pa to generate plasma. The substrate side (sample stage) also receives an RF (13.56 MHz) power of 10 W to be applied with a substantially negative self-bias voltage. In the second etching step, the etching rate of the W film is 227.3 nm/min, the etching rate of the TaN film is 32.1 nm/min, the selection ratio of the W film to the TaN film is 7.1, the etching rate of the SiON film that is the gate insulating film 5007 is 33.7 nm/min, and the selection ratio of the W film to the SiON film is 6.83. In the case where SF₆ is used as the etching gas, the selection ratio relative to the gate insulating film 5007 is high as described above; therefore, reduction in the film thickness can be suppressed. In this embodiment, the film thickness of the gate insulating film 5007 is reduced by only about 8 nm.

By the second etching step, the taper angle of the W film is set to 70°. By the second etching step, second shape conductive layers 5017 to 5022 are formed. At this time, the first conductive layers are hardly etched to be first conductive layers 5017a to 5022a. Note that the first conductive layers 5017a to 5022a have almost the same size as the first conductive layers 5011a and 5016a. In practice, the width of the first conductive layer may be reduced by about 0.3 μm, namely about 0.6 μm in the total line width as compared to before the second etching step. However, there is almost no change in the size.

In the case of adopting, instead of the two-layer structure, the three-layer structure where a tungsten film with a thickness of 50 nm, an aluminum-silicon alloy (Al—Si) film with a thickness of 500 mm, and a titanium nitride film with a thickness of 30 nm are stacked in this order, a first etching step is performed under first and second etching conditions. Specifically, the first etching step is performed for 117 seconds under the first etching condition that BCl₃, Cl₂ and O₂ are used as material gases, the flow rate of the gases is set to 65, 10, and 5 sccm respectively, an RF (13.56 MHz) power of 300 W is applied to the substrate side (sample stage), and an RF (13.56 MHz) power of 450 W is applied to a coiled electrode at a pressure of 1.2 Pa to generate plasma. In addition, the first etching step is performed for about 30 seconds under the second etching condition that CF₄, Cl₂ and O₂ are used, the flow rate of the gases is set to 25, 25, and 10 sccm respectively, an RF (13.56 MHz) power of 20 W is also applied to the substrate side (sample stage), and an RF (13.56 MHz) power of 500 W is applied to a coiled electrode at a pressure of 1.0 Pa to generate plasma. A second etching step is performed under the conditions that BCl₃ and Cl₂ are used, the flow rate of the gases is set to 20 and 60 sccm respectively, an RF (13.56 MHz) power of 100 W is applied to the substrate side (sample stage), and an RF (13.56 MHz) power of 600 W is applied to a coiled electrode at a pressure of 1.2 Pa to generate plasma.

After the resist mask is removed, a first doping step is performed to obtain a state shown in FIG. 16D. The doping step may be performed by ion doping or ion implantation. Ion doping is performed under the conditions that the dosage is 1.5×10¹⁴ atoms/cm² and the accelerating voltage is 60 to 100 keV. As an impurity element imparting N-type conductivity, phosphorous (P) or arsenic (As) is typically used. In this case, first impurity regions 5023 to 5026 are formed in a self-aligned manner using the first conductive layers and the second shape conductive layers 5017 to 5021 as masks. An impurity element imparting N-type conductivity is added to the first impurity regions 5023 to 5026 at a concentration of 1×10¹⁶ to 1×10¹⁷ atoms/cm³. Here, the region having the same concentration range as the first impurity regions is also called an n⁻ region.

Although the first doping step is performed after removing the resist mask in this embodiment, it may be performed without removing the resist mask.

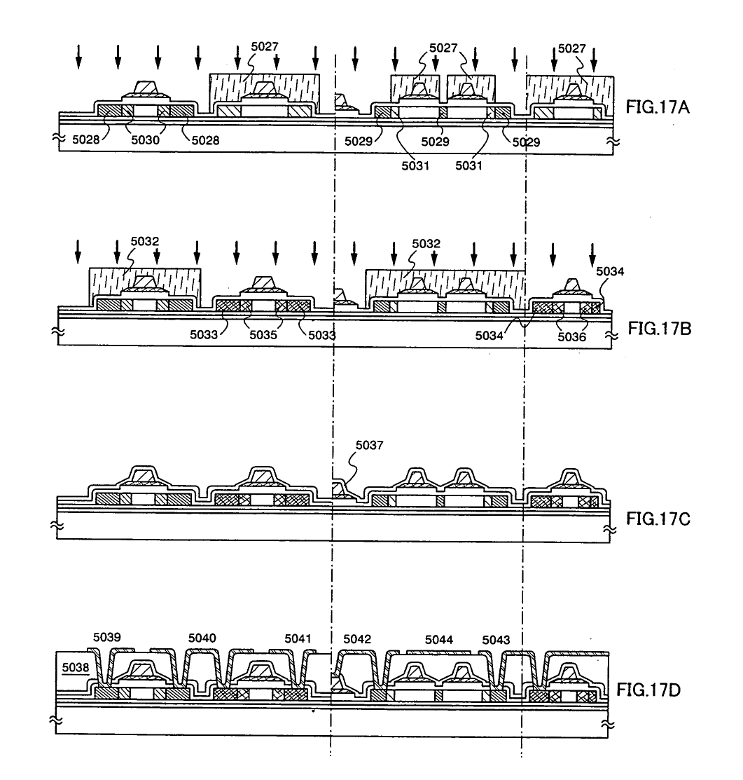

As shown in FIG. 17A, a resist mask 5027 is formed to perform a second doping step. In the second doping step, phosphorous (P) is added by ion doping under the conditions that the dosage is 1.5×10¹⁵ atoms/cm² and the accelerating voltage is 60 to 100 keV. In this embodiment, an impurity region is formed in each semiconductor layer in a self-aligned manner using second conductive layers 5017b to 5021b as masks. It is needless to say that a region covered with the mask 5027 is not doped with phosphorous. In this manner, second impurity regions 5028 and 5029 and a third impurity region 5030 are obtained. An impurity element imparting N-type conductivity is added to the second impurity regions 5028 and 5029 at a concentration of 1×10²⁰ to 1×10²¹ atoms/cm³. Here, the region having the same concentration range as the second impurity regions is also called an n⁺ region.

The third impurity region is formed at a lower concentration than the second impurity region because of the first conductive layer 5017a, and added with the impurity element imparting N-type conductivity at a concentration of 1×10¹⁸ to 1×10¹⁹ atoms/cm³. Note that since the third impurity region is added with the impurity element through the first conductive layer 5017a having a tapered shape, the third impurity region has a concentration gradient in which the impurity concentration increases toward the end portion of the tapered portion. Here, the region having the same concentration range as the third impurity region is also called an n⁻ region. A region 5031 covered with the mask 5027 is not added with the impurity element in the second doping step, and the first impurity region remains therein.

After the resist mask 5027 is removed, another resist mask 5032 is formed, and a third doping step is performed as shown in FIG. 17B.

By the third doping step, fourth impurity regions 5033 and 5034 and fifth impurity regions 5035 and 5036 added with an impurity element imparting P-type conductivity are formed in a semiconductor layer constituting a P-channel TFT and a semiconductor layer constituting a storage capacitor in a driver circuit.

The impurity element imparting P-type conductivity is added to the fourth impurity regions 5033 and 5034 at a concentration of 1×10²⁰ to 1×10²¹ atoms/cm³. Note that although the fourth impurity regions 5033 and 5034 are the regions (n⁻ regions) that have been added with phosphorous (P) in the precedent step, they have P-type conductivity since the impurity element imparting P-type conductivity is added thereto at a concentration 1.5 to 3 times that of phosphorous. Here, the region having the same concentration range as the fourth impurity regions is also called a p⁺ region.

The fifth impurity regions 5035 and 5036 are formed in the overlapping area with the tapered portions of the second conductive layers 5018b and 5021b respectively, and added with the impurity element imparting P-type conductivity at a concentration of 1×10¹⁸ to 1×10²⁰ atoms/cm³. Here, the region having the same concentration range as the fifth impurity regions is also called a p⁻ region.

By the aforementioned steps, the impurity regions having N-type or P-type conductivity are formed in each semiconductor layer. The conductive layers 5017 to 5020 serve as gate electrodes of the TFTs. The conductive layer 5021 serves as one electrode of the storage capacitor in the pixel portion. Further, the conductive layer 5022 constitutes a source signal line in the pixel portion.

Next, an insulating film (not shown) is formed to cover almost the entire surface. In this embodiment, a silicon oxide film with a thickness of 50 nm is formed by plasma CVD. Needless to say, the insulating film is not limited to the silicon oxide film, and other insulating films containing silicon may be used as a single layer structure or a stacked layer structure.

A step of activating the impurity elements added to the respective semiconductor layers is performed. This activating step is performed by rapid thermal annealing (RTA) using a lamp light source, irradiation of a YAG laser or an excimer laser from the back surface, or heat treatment using a furnace, or by combining any of them.

Although the insulating film is formed before the activating step in this embodiment, it may be formed after the activating step.

A first interlayer insulating film 5037 made of a silicon nitride film is formed, and then heat treatment (at a temperature of 300 to 550° C. for 1 to 12 hours) is performed, thereby a step of hydrogenating the semiconductor layers is performed (FIG. 17C). This step is a step of terminating dangling bonds of the semiconductor layers by hydrogen contained in the first interlayer insulating film 5037. The semiconductor layers can be hydrogenated independently of an insulating film (not shown) made of a silicon oxide film.

A second interlayer insulating film 5038 made of an organic insulating material is formed over the first interlayer insulating film 5037. In this embodiment, an acrylic resin film with a thickness of 1.6 μm is formed. Subsequently, a contact hole connected to each electrode or impurity region is formed. In this embodiment, a plurality of etching steps are sequentially performed. Specifically, after the second interlayer insulating film 5038 is etched using the first interlayer insulating film 5037 as an etching stopper, the first interlayer insulating film 5037 is etched using an insulating film (not shown) as an etching stopper, and then the insulating film (not shown) is etched.

A wiring and a pixel electrode are formed using Al, Ti, Mo, W, or the like. The wiring and the pixel electrode are desirably formed using a film mainly containing Al or Ag, or stacked layers of them with high reflectivity. Thus, wirings 5039 to 5042, a pixel electrode 5043, and a gate signal line 5044 are obtained.

In this manner, the driver circuit having the N-channel TFT and the P-channel TFT, and the pixel portion having the pixel TFT (N-channel TFT) and the storage capacitor can be formed over the same substrate (FIG. 17D). In this specification, such a substrate is referred to as an active matrix substrate for convenience.

In the active matrix substrate shown in FIG. 17D, the N-channel TFT has two kinds of structures. One is a GOLD structure having the third impurity region that overlaps the gate electrode as shown in the N-channel TFT in the driver circuit, and the other is an LDD structure having the first impurity region that does not overlap the gate electrode as shown in the pixel TFT.

The GOLD structure is suitable for suppressing hot carrier degradation and the like, and preferably used for a portion required to operate with high reliability. The LDD structure is suitable for reducing off-current leakage, and preferably used for a circuit that is often applied with a negative bias voltage, a circuit for controlling a pixel portion, and the like.

An opposite substrate 5045 is prepared. On the opposite substrate side, an opposite electrode 5046 made of a transparent conductive film is formed.

Alignment films 5047 and 5048 are formed on the opposite substrate side and the active matrix substrate side respectively, and rubbing treatment is performed. In this embodiment, before forming the alignment film 5048 on the active matrix substrate side, a columnar spacer (not shown) for making a space between the substrates is formed in a desired position using an organic resin film such as acrylic resin. Instead of the columnar spacer, a spherical spacer may be formed (sprayed) over the entire surface of the substrate.

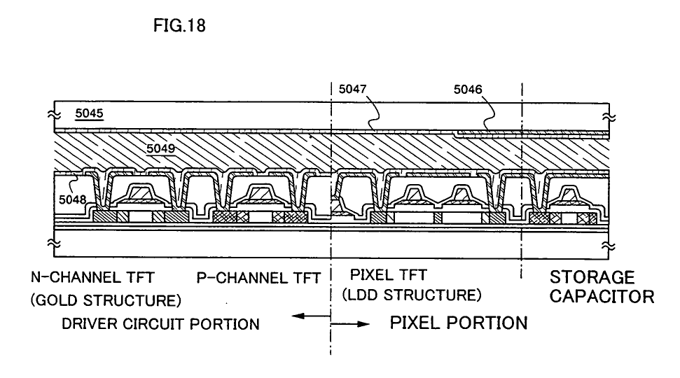

The counter substrate is attached to the active matrix substrate including the pixel portion and the driver circuit with a sealing member (not shown). Filler is mixed into the sealing member in advance, and the filler and the columnar spacer allow the two substrates to be attached to have an even space. Then, a liquid crystal material 5049 is injected into the space between the two substrates and completely sealed with a sealant (not shown). A known liquid crystal material may be used as the liquid crystal material 5049. The active matrix substrate or the opposite substrate is cut into a desired shape if necessary. Further, a polarizer and the like are appropriately provided by a known method. Then, an FPC is attached by a known method. In this manner, an active matrix liquid crystal display device shown in FIG. 18 is completed.

### EMBODIMENT 5

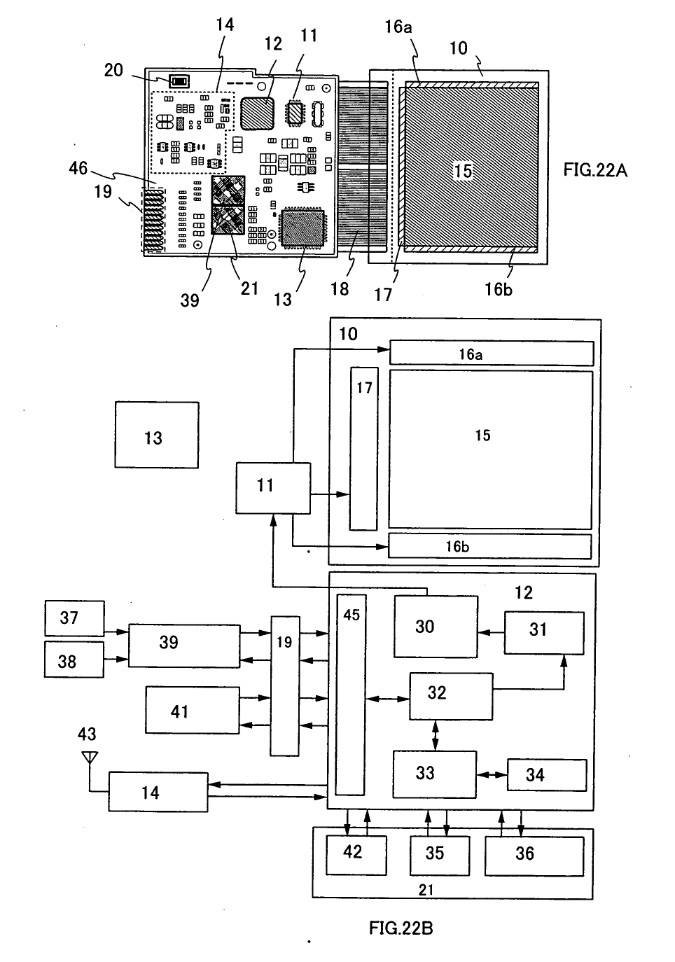

A liquid crystal display device shown in FIG. 22A has a printed wiring board 46 mounting a controller 11, a central processing unit (CPU) 12, a memory 21, a power supply circuit 13, a sound processing circuit 39, and a transmitting/receiving circuit 14 as well as elements such as a resistor, a buffer and a capacitor. A liquid crystal panel 10 is connected to the printed wiring board 46 through a flexible printed circuit (FPC) 18.

The liquid crystal panel 10 includes a source signal line driver circuit 17, a first gate signal line driver circuit 16a, and a second gate signal line driver circuit 16b. The scanning direction of the second gate signal line driver circuit is perpendicular to that of the first gate signal line driver circuit. This configuration is similar to that shown in FIG. 1A. The liquid crystal panel 10 is driven by the field sequential method, and it is therefore not necessary to divide a pixel in a pixel portion 15 into RGB. Thus, a smaller number of signal lines are required, and the opening ratio can be significantly improved.

Various control signals are inputted/outputted through an interface (I/F) 19 mounted on the printed wiring board 46. An antenna port 20 is provided over the printed wiring board 46 to transmit/receive signals to/from an antenna.

Although the printed wiring board 46 is connected to the liquid crystal panel 10 through an FPC 18 in this embodiment, the invention is not limited to this configuration. The controller 11, the sound processing circuit 39, the memory 21, the CPU 12, and the power supply circuit 13 may be directly mounted on the liquid crystal panel 10 by COG (Chip On Glass). The elements such as a capacitor and a buffer formed over the printed wiring board 46 prevent noise from entering a power supply voltage or a signal, and prevent the rising edge of a signal from being rounded.

FIG. 22B is a block diagram of the liquid crystal display device shown in FIG. 22A. The liquid crystal display device has the memory 21 including a VRAM 42, a DRAM 35, a flash memory 36 and the like. The VRAM 42 stores image data to be displayed on the panel, the DRAM 35 stores image data or sound data, and the flash memory 36 stores various kinds of programs.

In the power supply circuit 13, a power supply voltage is generated to be supplied to the liquid crystal panel 10, the controller 11, the CPU 12, the sound processing circuit 39, the memory 21, and the transmitting/receiving circuit 14. The power supply circuit 13 may include a current source depending on the specifications of the panel.

The CPU 12 includes a control signal generating circuit 30, a decoder 31, a register 32, an arithmetic circuit 33, a RAM 34, an interface 45 for the CPU, and the like. Various signals inputted to the CPU 12 through the interface 45 are stored in the register 32, and then inputted to the arithmetic circuit 33, the decoder 31 and the like. The arithmetic circuit 33 performs an arithmetic operation in accordance with an inputted signal, and specifies an address to which various instructions are transmitted. A signal inputted to the decoder 31 is decoded and inputted to the control signal generating circuit 30. The control signal generating circuit 30 generates a signal including various instructions in accordance with an inputted signal, and transmits the generated signal to an address specified by the arithmetic circuit 33, specifically the memory 21, the transmitting/receiving circuit 14, the sound processing circuit 39, the controller 11 and the like.

The memory 21, the transmitting/receiving circuit 14, the sound processing circuit 39, and the controller 11 operate in accordance with the respective instructions. The operation is briefly described below.

A signal inputted from an inputting means 41 is transmitted to the CPU 12 mounted on the printed wiring board 46 through the interface 19. The control signal generating circuit 30 converts image data stored in the VRAM 42 into a predetermined format in accordance with a signal transmitted from the inputting means 41 such as a pointing device and a keyboard, and then transmits the converted data to the controller 11.

The controller 11 processes a signal including image data transmitted from the CPU 12 in accordance with the specifications of the panel, and inputs the processed signal to the liquid crystal panel 10. The controller 11 generates an Hsync signal, a Vsync signal, a clock signal CLK, an AC voltage (AC cont), and a switching signal L/R in accordance with a power supply voltage inputted from the power supply circuit 13 and various signals inputted from the CPU 12, and then transmits the generated signals to the liquid crystal panel 10.

The transmitting/receiving circuit 14 processes a signal transmitted/received as a radio wave by an antenna 43. Specifically, the transmitting/receiving circuit 14 includes an RF circuit such as an isolator, a band path filter, a VCO (Voltage Controlled Oscillator), an LPF (Low Pass Filter), a coupler, and a balun. Some of the signals transmitted/received by the transmitting/receiving circuit 14, which include sound data, are transmitted to the sound processing circuit 39 in accordance with the instruction from the CPU 12.

A signal including sound data, which is transmitted in accordance with the instruction from the CPU 12, is demodulated to a sound signal by the sound processing circuit 39, and transmitted to a speaker 38. A sound signal transmitted from a microphone 37 is modulated by the sound processing circuit 39, and transmitted to the transmitting/receiving circuit 14 in accordance with the instruction from the CPU 12.

The controller 11, the CPU 12, the power supply circuit 13, the sound processing circuit 39, and the memory 21 may be packaged in this embodiment. This embodiment may be applied to any circuit other than an RF circuit such as an isolator, a band path filter, a VCO (Voltage Controlled Oscillator), an LPF (Low Pass Filter), a coupler, and a balun.

According to this embodiment, the screen can be easily switched between the vertical direction and the horizontal direction. In addition, the liquid crystal display device can be obtained without a complicated external circuit.

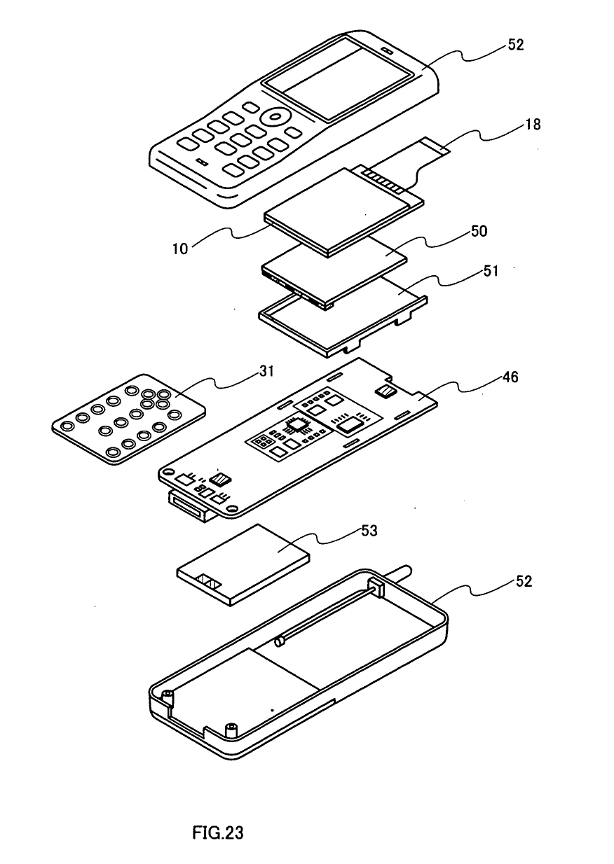

FIG. 23 shows one mode of a mobile phone having the liquid crystal display device. The liquid crystal panel 10 is mounted in a housing 51 so as to be easily detachable, thereby integration with the liquid crystal display device is facilitated. The housing 51 can be changed in form and size depending on an electronic apparatus mounted in the housing 51.

The liquid crystal panel 10 adopting the field sequential method is combined with a light source 50 that periodically changes its emission color. The light source 50 is constituted by an optical waveguide and light emitting diodes with different emission colors. Alternatively, the light source 50 may be formed using an organic EL element, an inorganic EL element, or a composite EL element utilizing synergy between an organic material and an inorganic material. The housing 51 to which the liquid crystal panel 10 and the light source 50 are fixed is attached to the printed wiring board 46 and built as a module.

The printed wiring board 46 mounts a controller, a CPU, a memory, and a power supply circuit as well as elements such as a resistor, a buffer and a capacitor. In addition, a sound processing circuit, a transmitting/receiving circuit and the like may be mounted depending on the application. The liquid crystal panel 10 is connected to the printed wiring board 46 through the FPC 18.

The liquid crystal display device, the inputting means 41 and a battery 53 are placed in a housing 52. A pixel portion of the liquid crystal panel 10 is disposed so as to be seen through a window formed in the housing 52.

Since the liquid crystal panel 10 is driven by the field sequential method, a pixel in the pixel portion is not required to be divided into RGB. Accordingly, a smaller number of signal lines are required and the opening ratio can be significantly improved. In addition, a color filter can be omitted, leading to reduction in the weight and thickness of a mobile phone. Further, switching between the display in the vertical direction and the display in the horizontal direction allows the outline of the housing 52 to be designed freely. In other words, the invention is not limited to the mobile phone shown in FIG. 23, and the liquid crystal display device may be applied to electronic apparatuses having various outlines.

### EMBODIMENT 6

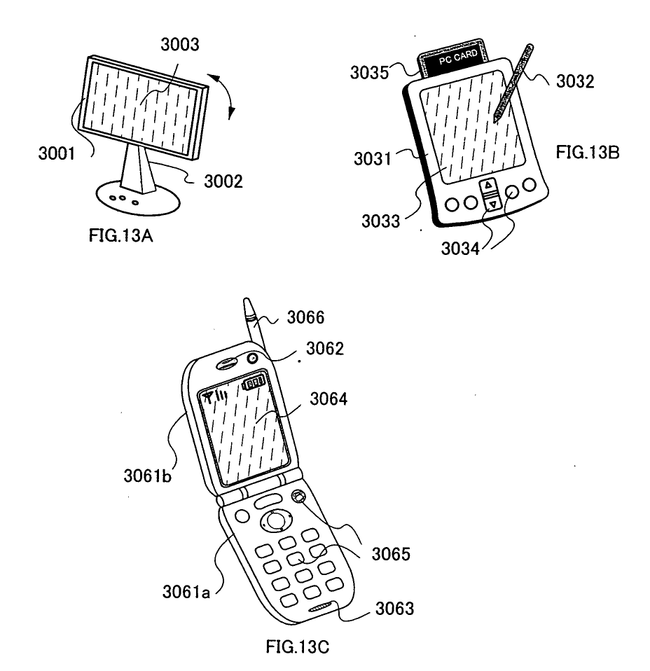

As described in Embodiment 5, the invention can be applied to a display device of various electronic apparatuses. Such electronic apparatuses include a display device, a portable information terminal (electronic book, mobile computer, and the like), a mobile phone, and the like. Specific examples of them are shown in FIGS. 13A to 13C.

FIG. 13A shows a liquid crystal display having a housing 3001, a support base 3002, a display portion 3003 and the like. The invention can be applied to the display portion 3003. In the case of switching between the display in the vertical direction and the display in the horizontal direction in such a desktop display, a rotating mechanism may be provided in a mounting portion of the housing 3001 for attachment to the support base 3002, so that the housing 3001 itself can be rotated.

FIG. 13B shows a portable information terminal having a main body 3031, a stylus 3032, a display portion 3033, operating buttons 3034, an external interface 3035 and the like. The invention can be applied to the display portion 3033. The portable information terminal can be easily switched between the display in the vertical direction and the display in the horizontal direction depending on contents displayed on the screen, and images can be displayed with high quality.

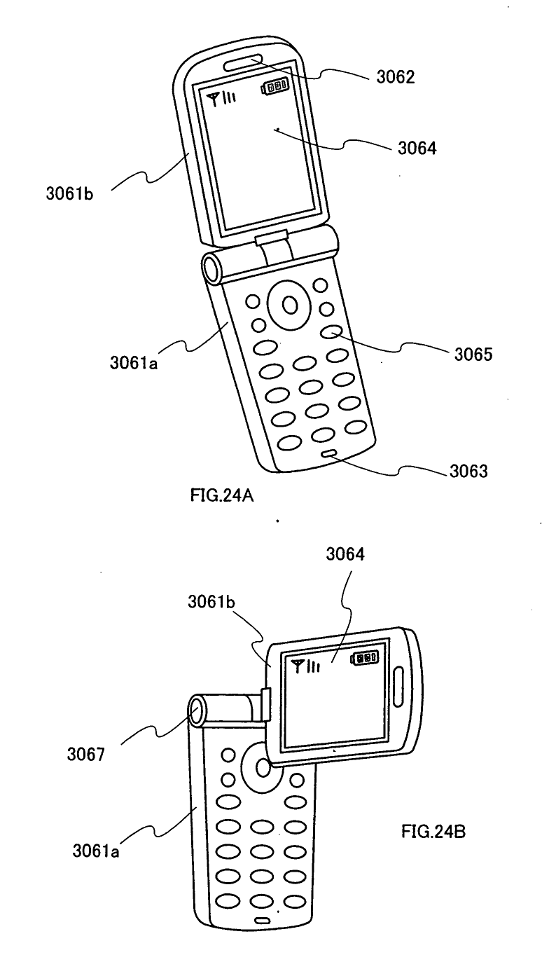

FIG. 13C shows a mobile phone having a main body(A) 3061a provided with a sound inputting portion 3063, operating buttons 3065 and the like, and a main body(B) 3061b provided with a display portion 3064, a sound outputting portion 3062, an antenna 3066 and the like. The invention can be applied to the display portion 3064. The mobile phone can be easily switched between the display in the vertical direction and the display in the horizontal direction depending on contents displayed on the screen, and images can be displayed with high quality. For example, as shown in FIGS. 24A and 24B, a rotating mechanism is provided in a hinge portion 3067 for connecting the main body(A) 3061a and the main body(B) 3061b, so that the main body(B) 3061b itself can be rotated. It is useful to incorporate a camera by providing an imaging element such as a CCD and a lens in the hinge portion 3067. When the display in the display portion 3064 is switched between the vertical direction and the horizontal direction by rotating the main body(B) 3061b, images can be taken while being displayed on the display portion 3064.

The examples shown in this embodiment are just examples, and the invention is not limited to these.

This application is based on Japanese Patent Application serial No. 2004-292010 filed in Japan Patent Office on Oct. 4, 2004, the entire contents of which are hereby incorporated by reference.

What is claimed is:

1. A display device comprising a light source that periodically changes an emission color, a source signal line driver circuit, a first gate signal line driver circuit, a second gate signal line driver circuit, and a plurality of pixels,
wherein a scanning direction of the first gate signal line driver circuit is perpendicular to that of the second gate signal line driver circuit.

2. A device according to claim 1,
wherein in a first display, a driving frequency of the source signal line driver circuit is higher than that of the first gate signal line driver circuit; and
in a second display, a driving frequency of the source signal line driver circuit is lower than that of the first gate signal line driver circuit.

3. A device according to claim 1,
wherein in a first display, an image is displayed in the scanning direction of the first gate signal line driver circuit; and
in a second display, an image is displayed in the scanning direction of the second gate signal line driver circuit.

4. A device according to claim 1,
wherein each of the plurality of pixels comprises a liquid crystal element.

5. A device according to claim 1,
wherein at least one of the signal line driver circuits and the plurality of pixels are formed over the same substrate.

6. An electronic apparatus using the display device according to claim 1.

7. A display device comprising a light source that periodically changes an emission color, a source signal line driver circuit, a first gate signal line driver circuit, a second gate signal line driver circuit, and a plurality of pixels,
wherein each of the plurality of pixels includes a source signal line, a first gate signal line, a second gate signal line perpendicular to the first gate signal line, a first transistor, and a second transistor;
a gate electrode of the first transistor is electrically connected to the first gate signal line, and an input electrode thereof is electrically connected to the source signal line while an output electrode is electrically connected to an input electrode of the second transistor; and
a gate electrode of the second transistor is electrically connected to the second gate signal line.

8. A device according to claim 7,
wherein in a first display, a driving frequency of the source signal line driver circuit is higher than that of the first gate signal line driver circuit; and
in a second display, a driving frequency of the source signal line driver circuit is lower than that of the first gate signal line driver circuit.

9. A device according to claim 7,
wherein in a first display, an image is displayed in the scanning direction of the first gate signal line driver circuit; and
in a second display, an image is displayed in the scanning direction of the second gate signal line driver circuit.

10. A device according to claim 7,
wherein each of the plurality of pixels comprises a liquid crystal element.

11. A device according to claim 7,
wherein at least one of the signal line driver circuits and the plurality of pixels are formed over the same substrate.

12. An electronic apparatus using the display device according to claim 7.

13. A display device comprising a light source that periodically changes an emission color, a first source signal line driver circuit, a second source signal line driver circuit, a first gate signal line driver circuit, a second gate signal line driver circuit, and a plurality of pixels,
wherein a scanning direction of the first gate signal line driver circuit is perpendicular to that of a second gate signal line driver circuit.

14. A device according to claim 13,
wherein in a first display, an image is displayed in the scanning direction of the first gate signal line driver circuit; and
in a second display, an image is displayed in the scanning direction of the second gate signal line driver circuit.

15. A device according to claim 13,
wherein each of the plurality of pixels comprises a liquid crystal element.

16. A device according to claim 13,
wherein at least one of the signal line driver circuits and the plurality of pixels are formed over the same substrate.

17. An electronic apparatus using the display device according to claim 13.

18. A display device comprising a light source that periodically changes an emission color, a first source signal line driver circuit, a second source signal line driver circuit, a first gate signal line driver circuit, a second gate signal line driver circuit, and a plurality of pixels,
wherein each of the plurality of pixels includes a first source signal line, a second source signal line, a first gate signal line, a second gate signal line perpendicular to the first gate signal line, a first transistor, and a second transistor;
a gate electrode of the first transistor is electrically connected to the first gate signal line, and an input electrode thereof is electrically connected to the first source signal line; and
a gate electrode of the second transistor is electrically connected to the second gate signal line, and an input electrode thereof is electrically connected to the second source signal line.

19. A device according to claim 18,
wherein in a first display, an image is displayed in the scanning direction of the first gate signal line driver circuit; and
in a second display, an image is displayed in the scanning direction of the second gate signal line driver circuit.

20. A device according to claim 18,
wherein each of the plurality of pixels comprises a liquid crystal element.

21. A device according to claim 18,
wherein at least one of the signal line driver circuits and the plurality of pixels are formed over the same substrate.

22. An electronic apparatus using the display device according to claim 18.

23. A driving method of a display device comprising a source signal line driver circuit, a first gate signal line driver circuit, a second gate signal line driver circuit, and a plurality of pixels,
wherein a scanning direction of the first gate signal line driver circuit is perpendicular to that of the second gate signal line driver circuit,
said method comprising:
driving the plurality of pixels by a field sequential method.

24. A method according to claim 23,
wherein in a first display, a driving frequency of the source signal line driver circuit is higher than that of the first gate signal line driver circuit; and
in a second display, a driving frequency of the source signal line driver circuit is lower than that of the first gate signal line driver circuit.

25. A method according to claim 23,
wherein in a first display, an image is displayed in the scanning direction of the first gate signal line driver circuit;
in a second display, an image is displayed in the scanning direction of the second gate signal line driver circuit; and
the plurality of pixels are driven by a field sequential method.

26. A method according to claim 23,
wherein each of the plurality of pixels comprises a liquid crystal element.

27. A method according to claim 23,
wherein at least one of the signal line driver circuits and the plurality of pixels are formed over the same substrate.

28. An electronic apparatus using the driving method according to claim 23.

29. A driving method of a display device comprising a source signal line driver circuit, a first gate signal line driver circuit, a second gate signal line driver circuit, and a plurality of pixels,
wherein each of the plurality of pixels includes a source signal line, a first gate signal line, a second gate signal line perpendicular to the first gate signal line, a first transistor, and a second transistor;
a gate electrode of the first transistor is electrically connected to the first gate signal line, and an input electrode thereof is electrically connected to the source signal line while an output electrode thereof is electrically connected to an input electrode of the second transistor; and
a gate electrode of the second transistor is electrically connected to the second gate signal line,
said method comprising:
driving the plurality of pixels by a field sequential method.

30. A method according to claim 29,
wherein in a first display, a driving frequency of the source signal line driver circuit is higher than that of the first gate signal line driver circuit; and
in a second display, a driving frequency of the source signal line driver circuit is lower than that of the first gate signal line driver circuit.

31. A method according to claim 29,
wherein in a first display, an image is displayed in the scanning direction of the first gate signal line driver circuit;
in a second display, an image is displayed in the scanning direction of the second gate signal line driver circuit; and
the plurality of pixels are driven by a field sequential method.

32. A method according to claim 29,
wherein each of the plurality of pixels comprises a liquid crystal element.

33. A method according to claim 29,
wherein at least one of the signal line driver circuits and the plurality of pixels are formed over the same substrate.

34. An electronic apparatus using the driving method according to claim 29.

35. A driving method of a display device comprising a first source signal line driver circuit, a second source signal line driver circuit, a first gate signal line driver circuit, a second gate signal line driver circuit, and a plurality of pixels,
wherein a scanning direction of the first gate signal line driver circuit is perpendicular to that of the second gate signal line driver circuit,
said method comprising:
driving the plurality of pixels by a field sequential method.

36. A method according to claim 35,
wherein in a first display, an image is displayed in the scanning direction of the first gate signal line driver circuit;
in a second display, an image is displayed in the scanning direction of the second gate signal line driver circuit; and
the plurality of pixels are driven by a field sequential method.

37. A method according to claim 35,
wherein each of the plurality of pixels comprises a liquid crystal element.

38. A method according to claim 35,
wherein at least one of the signal line driver circuits and the plurality of pixels are formed over the same substrate.

39. An electronic apparatus using the driving method according to claim 35.

40. A driving method of a display device comprising a first source signal line driver circuit, a second source signal line driver circuit, a first gate signal line driver circuit, a second gate signal line driver circuit, and a plurality of pixels,
wherein each of the plurality of pixels includes a first source signal line, a second source signal line, a first gate signal line, a second gate signal line perpendicular to the first gate signal line, a first transistor, and a second transistor;
a gate electrode of the first transistor is electrically connected to the first gate signal line, and an input electrode thereof is electrically connected to the first source signal line; and
a gate electrode of the second transistor is electrically connected to the second gate signal line, and an input electrode thereof is electrically connected to the second source signal line,
said method comprising:
driving the plurality of pixels by a field sequential method.

41. A method according to claim 40,
wherein in a first display, an image is displayed in the scanning direction of the first gate signal line driver circuit;
in a second display, an image is displayed in the scanning direction of the second gate signal line driver circuit; and
the plurality of pixels are driven by a field sequential method.

42. A method according to claim 40,
wherein each of the plurality of pixels comprises a liquid crystal element.

43. A method according to claim 40,
wherein at least one of the signal line driver circuits and the plurality of pixels are formed over the same substrate.

44. An electronic apparatus using the driving method according to claim 40.
